(19) United States
(12) Patent Application Publication
(10) Pub. No.: US 2025/0355681 A1
(43) Pub. Date: Nov. 20, 2025

(54) AUTOMATION OF REPEATED USER OPERATIONS

(71) Applicant: CITRIX SYSTEMS, INC., Fort Lauderdale, FL (US)

(72) Inventors: JIA YIN, NANJING (CN); JIAN LUO, NANJING (CN); YUHAN YAO, NANJING (CN); JIE ZHUANG, NANJING (CN)

(21) Appl. No.: 18/873,390

(22) PCT Filed: Sep. 28, 2022
(86) PCT No.: PCT/CN2022/121950

§ 371 Date: Dec. 10, 2024

(51) Int. Cl. G06F 9/451; G06F 16/955

(52) U.S. Cl. CPC G06F 9/451; G06F 16/955

(57) ABSTRACT

In some disclosed embodiments, a computing device may determine that a script identifies first pixel data and at least one first action associated with the first pixel data, and determine that first pixels being displayed on a screen of the computing device correspond to the first pixel data identified in the script. Based at least in part on the first pixels corresponding to the first pixel data and the at least one first action being associated with the first pixel data in the script, the computing device may take the at least one first action at first coordinates corresponding to a first location on the screen at which of the first pixels are being displayed

### BACKGROUND

Various systems have been developed that allow client devices to access applications and/or data files over a network. Certain products offered by Citrix Systems, Inc., of Fort Lauderdale, FL, including the Citrix Workspace™ family of products, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method comprises determining, in response to at least one first input to a user interface of a computing system, that at least one first action is to be taken with respect to a first user interface (UI) element being displayed by the user interface; determining, by the computing system, first pixel data corresponding to the first UI element; and generating, by the computing system, a script configured to determine that first pixels corresponding to the first pixel data are being displayed on a screen of a computing device, and to based at least in part on the first pixels corresponding to the first pixel data, cause the computing device to take the at least one first action at first coordinates corresponding to a first location on the screen at which of the first pixels are being displayed.

In some disclosed embodiments, a method comprises determining, by a computing device, that a script identifies first pixel data and at least one first action associated with the first pixel data; determining that first pixels being displayed on a screen of the computing device correspond to the first pixel data identified in the script; and based at least in part on the first pixels corresponding to the first pixel data and the at least one first action being associated with the first pixel data in the script, causing the computing device to take the at least one first action at first coordinates corresponding to a first location on the screen at which of the first pixels are being displayed.

In some disclosed embodiments, a computing system comprises at least one processor, and at least one computer-readable medium encoded with instructions which, when executed by the at least one processor, cause the computing system to determine that a script identifies first pixel data and at least one first action associated with the first pixel data, to determine that first pixels being displayed on a screen of a computing device correspond to the first pixel data identified in the script, and to, based at least in part on the first pixels corresponding to the first pixel data and the at least one first action being associated with the first pixel data in the script, cause a computing device to take the at least one first action at first coordinates corresponding to a first location on the screen at which of the first pixels are being displayed.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example system configured to generate tokens for performing repeated actions using a web browsing application, in accordance with some embodiments;

FIG. 1B shows a first example user interface screen of a computing device shown in FIG. 1A, in accordance with some embodiments;

FIG. 1C shows a second example user interface screen of a computing device shown in FIG. 1A, in accordance with some embodiments;

FIG. 1D shows a third example user interface screen of a computing device shown in FIG. 1A, in accordance with some embodiments;

FIG. 1E shows a fourth example user interface screen of a computing device shown in FIG. 1A, in accordance with some embodiments;

FIG. 1F shows a fifth example user interface screen of a computing device shown in FIG. 1A, in accordance with some embodiments;

FIG. 1G shows a sixth example user interface screen of a computing device shown in FIG. 1A, in accordance with some embodiments;

FIG. 1H shows a seventh example user interface screen of a computing device shown in FIG. 1A, in accordance with some embodiments;

FIG. 1I shows a eighth example user interface screen of a computing device shown in FIG. 1A, in accordance with some embodiments;

FIG. 2A shows an example system configured to playback a token for performing repeated actions using a web browsing application, in accordance with some embodiments;

FIG. 2B shows a first example user interface screen of a computing device shown in FIG. 2A, in accordance with some embodiments;

FIG. 2C shows a second example user interface screen of a computing device shown in FIG. 2A, in accordance with some embodiments;

FIG. 2D shows a third example user interface screen of a computing device shown in FIG. 2A, in accordance with some embodiments;

FIG. 3 is a diagram of a network environment in which some embodiments of the system disclosed herein may be deployed, in accordance with some embodiments;

FIG. 4 is a block diagram of a computing system that may be used to implement one or more of the components of the computing environment shown in FIG. 3, in accordance with some embodiments;

FIG. 5 is a schematic block diagram of a cloud computing environment in which various aspects of the disclosure may be implemented, in accordance with some embodiments;

FIG. 6A is a block diagram of an example system in which resource management services may manage and streamline access by clients to resource feeds (via one or more gateway service) and/or software-as-a-service (SaaS) applications, in accordance with some embodiments;

FIG. 6B is a block diagram showing an example implementation of the system shown in FIG. 6A in which various resource management services as well as a gateway service are located within a cloud computing environment, in accordance with some embodiments;

FIG. 6C is a block diagram similar to that shown in FIG. 6B, but in which the available resources are represented by a single box labeled “systems of record,” and further in which several different service are included among the resource management services, in accordance with some embodiments;

FIG. 6D shows how a display screen may appear when an intelligent activity feed feature of a multi-resource management system, such as that shown in FIG. 6C, is employed, in accordance with some embodiments;

FIG. 7 illustrates example components that may be included in the systems that are shown in FIGS. 1A and 2A, in accordance with some embodiments;

FIG. 8 illustrates an example routine that may be performed by a token recording engine for recording a token workflow, in accordance with some embodiments;

FIG. 9 illustrates an example routine that may be performed by a token playback engine for executing an a token workflow, in accordance with some embodiments;

FIG. 10 illustrates an example routine including various processes for a token, in accordance with some embodiments; and

FIG. 11 is an example routine for a playback execution of a file access request token, in accordance with some embodiments.

### DETAILED DESCRIPTION

Software applications and internet services accessed via a web browser may include functionalities that a user repeats on a regular basis. For example, when accessing files stored by an internet-based file repository, users may be required to take the same sequence of steps to check out each of a plurality of files to prevent multiple users from modifying the file at the same time. Further, in some situations, a user may need to take such a sequence of steps to check out multiple files on a repeated basis.

In one example situation, a software developer may need access to multiple files that are part of their current project and each day, when the software developer begins work, they must go through the process of checking out each file individually. Developers may also have to download code from a file repository so that the software may be built on the developer's local machine to test features and debug the programming code. Such a repeated process may be tedious and time consuming for the user, as the user must perform the same duplicate interface interactions for multiple items (e.g., the checkout process for each file). These identical interactions may have to be performed on periodic basis, such as daily, weekly, or whenever a permission expires. Such identical interactions may also need to be repeated by each of multiple users (i.e., each member of a software development team that needs to perform the same checkout process).

Offered are systems and techniques for generating a script by detecting and recording one or more user input interactions with a graphical user interface (GUI). In some implementations, the recording process may capture pixel data of the GUI corresponding to the respective user input interactions, e.g., mouse clicks. For example, for each of a plurality of detected mouse clicks, data representing a set pixels (e.g., ten pixels) at particular locations relative to the location of the mouse click may be captured and recorded as a sequence of steps. The pixel data that is captured and recorded in this fashion is sometimes referred to herein as “recorded pixel data.”

Such a script may subsequently be executed by a computing system (which may be the same computing system or a different computing system) to cause that computing system to take the same set of actions with the same GUI on another occasion. In particular, for each step in the sequence, the script may cause the computing system to evaluate the pixel data that is currently being displayed by the computing system (e.g., by retrieving data from the screen buffer of the computing system) to determine whether it contains a pattern of pixels that matches, or substantially matches, the recorded pixel data for that step. In response to the computing system detecting a matching, or substantially matching, pattern of pixels, the script may cause the computing system to invoke a user input interaction, e.g., a mouse click, at a location of the GUI corresponding to the matching pixels. In some implementations, for example, a mouse click may be invoked at a position relative to the matching pixels that is the same as the position of the recorded mouse click relative to the captured pixels.

Such a script may thus cause a computing system to interact with a particular GUI to take a sequence of steps on behalf of a user based on what is being presented on a display screen, e.g., by evaluating the current contents of a screen buffer. Advantageously, a computing system in possession of such a script may take the designated sequence of steps with respect to a GUI without requiring access to the underlying application that is generating the GUI. A script that is configured in this fashion is sometimes referred to herein as a “token.”

For purposes of reading the description of the various embodiments below, the following descriptions of the sections of the specification and their respective contents may be helpful:
Section A provides an introduction to example embodiments of a system for automation of user operations in accordance with some aspects of the present disclosure;
Section B describes a network environment which may be useful for practicing embodiments described herein;
Section C describes a computing system which may be useful for practicing embodiments described herein;
Section D describes embodiments of systems and methods for accessing computing resources using a cloud computing environment;
Section E describes embodiments of systems and methods for managing and streamlining access by clients to a variety of resources;
Section F provides a more detailed description of example embodiments of the systems introduced in Section A; and
Section G describes example implementations of methods, systems/devices, and computer-readable media in accordance with the present disclosure.

### A. Introduction to Illustrative Embodiments of a System for Automation of User Operations

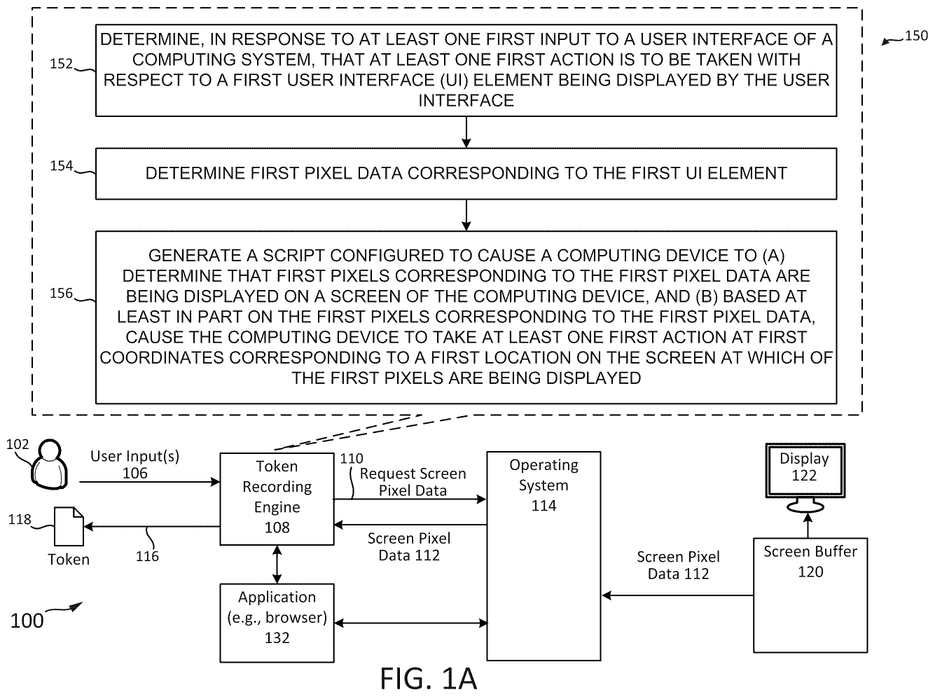

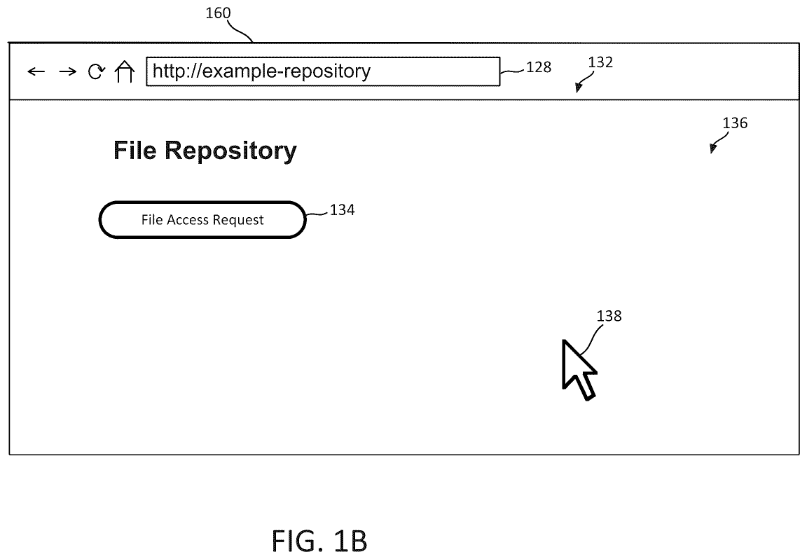

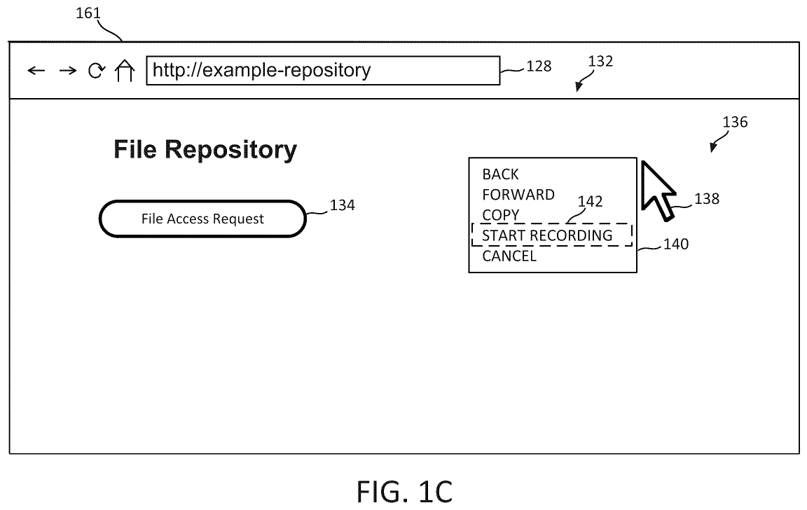

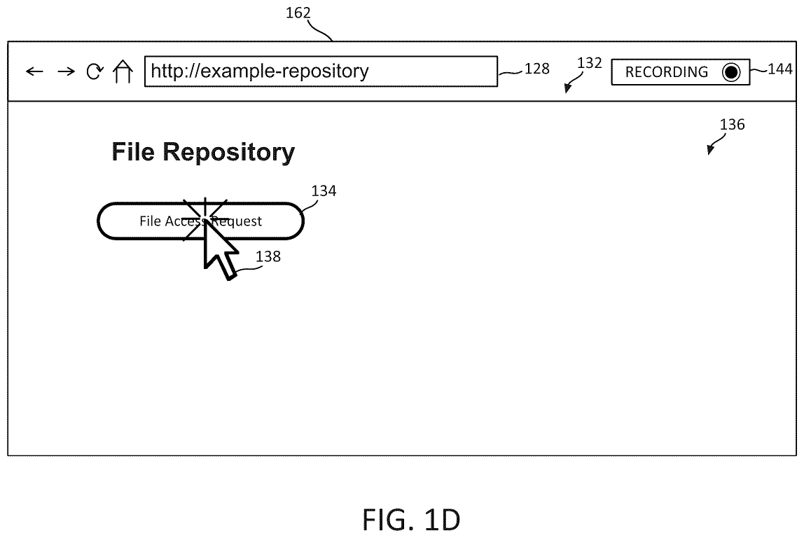

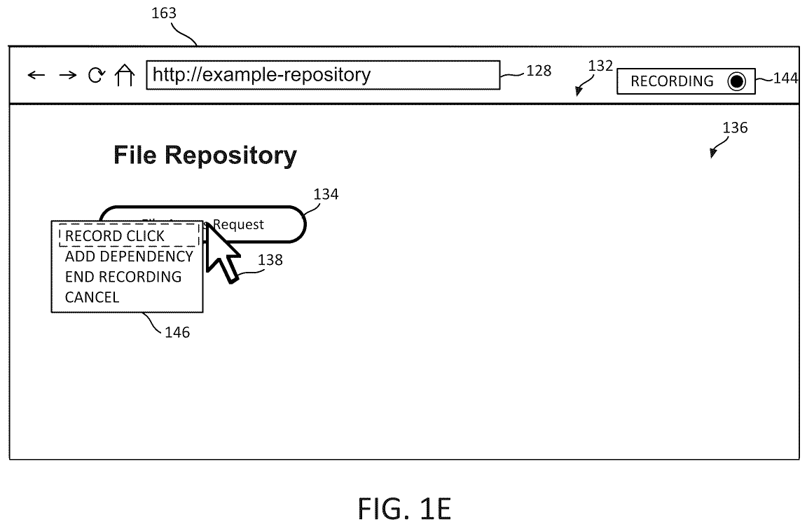

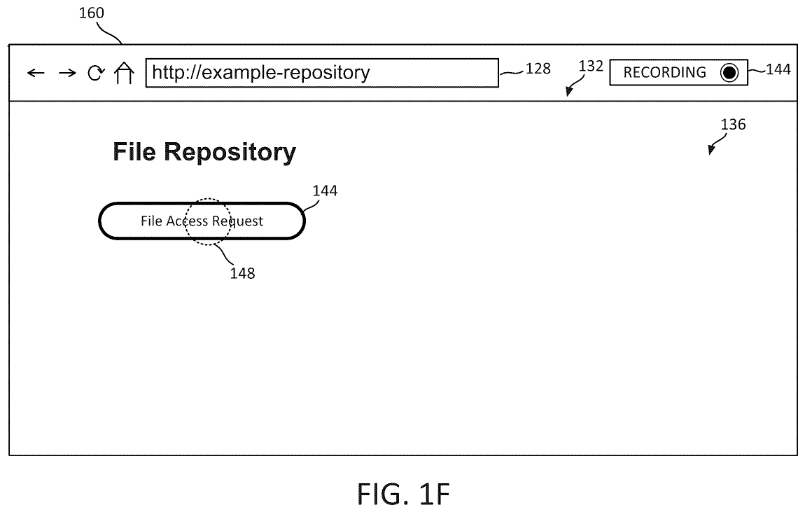

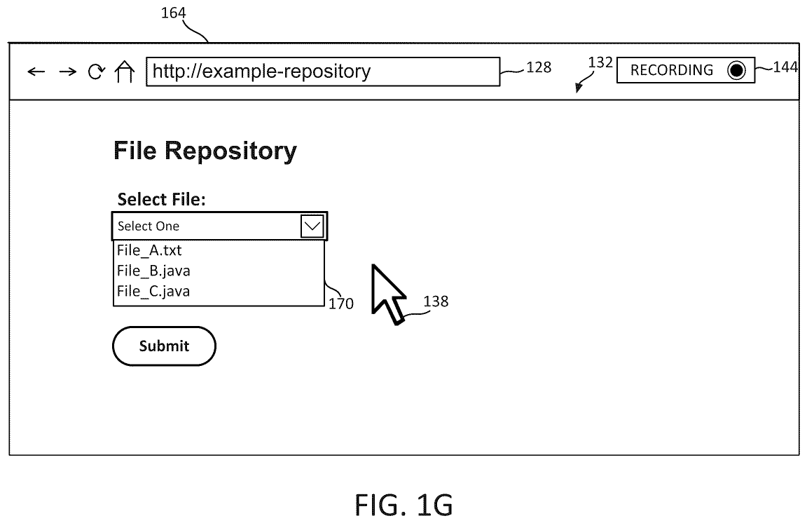

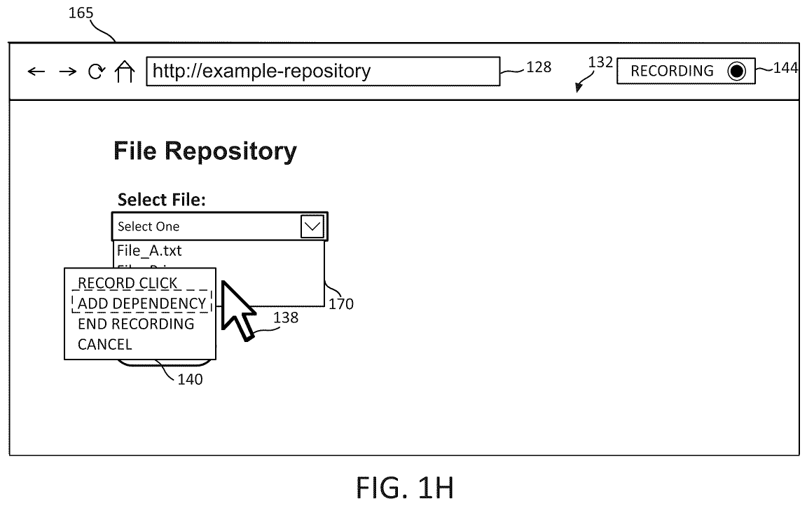

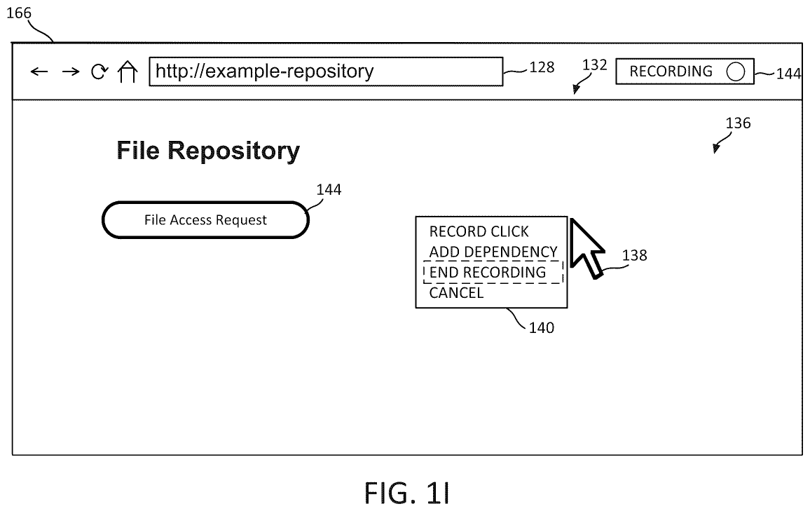

FIG. 1A is a diagram illustrating example operations of a system 100 for recording a UI interactive script (e.g., a token), in accordance with some embodiments of the present disclosure. As shown, in some implementations, the system 100 may include a token recording engine 108, an operating system 114, an application (e.g., a web browser 132), a screen buffer 120, and a display 122. In some implementations, for example, the components shown in FIG. 1A may be embodied by and/or operate in conjunction with a client device 302 (examples of which are described below in Sections B-E).

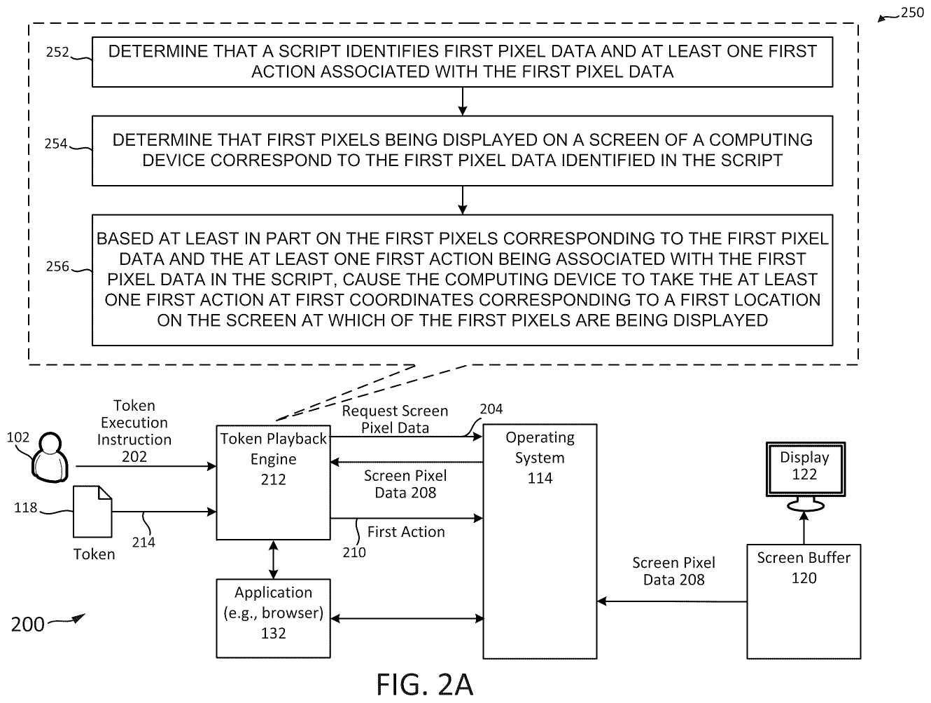

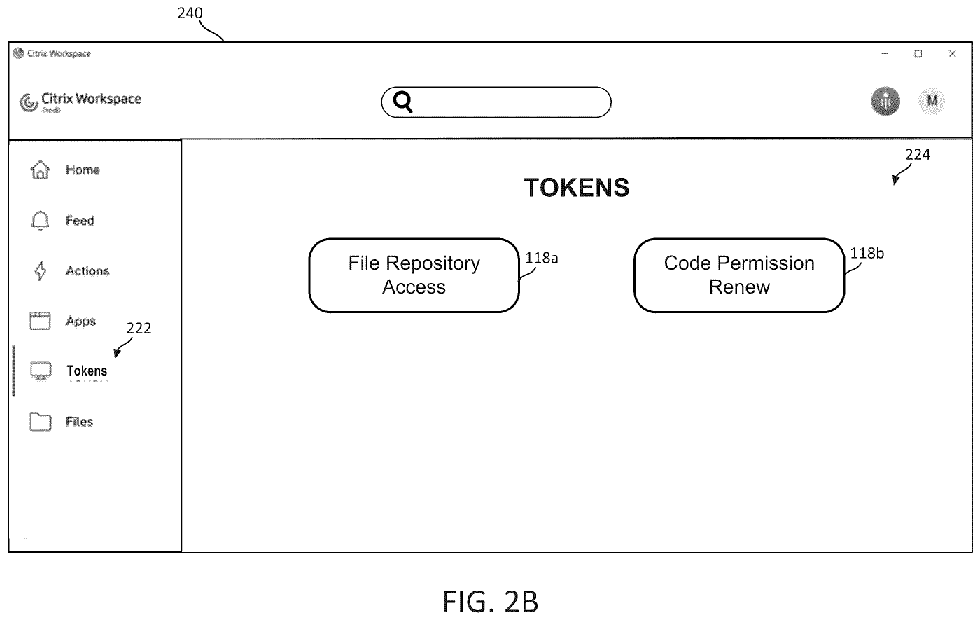

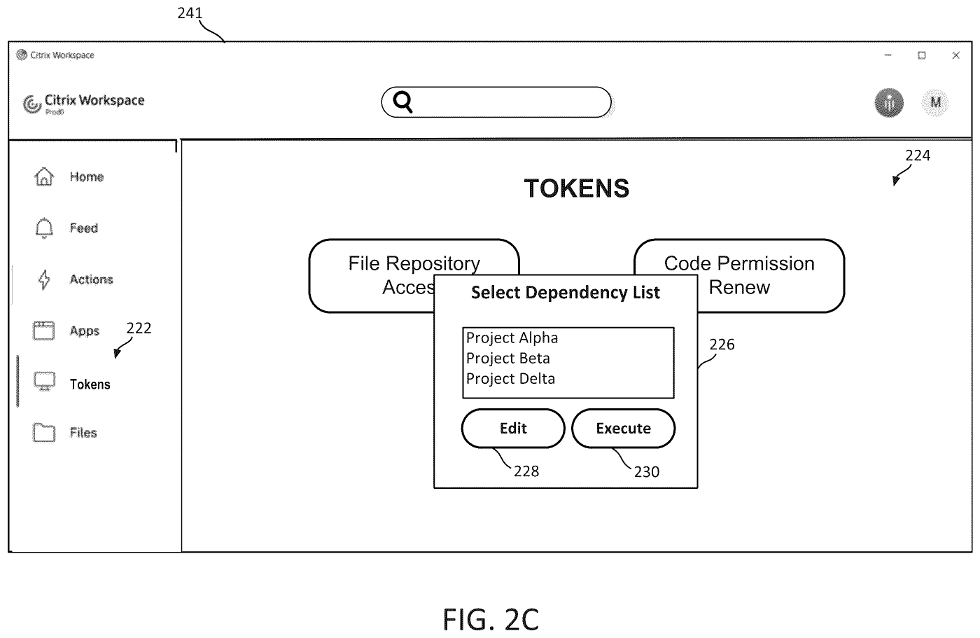

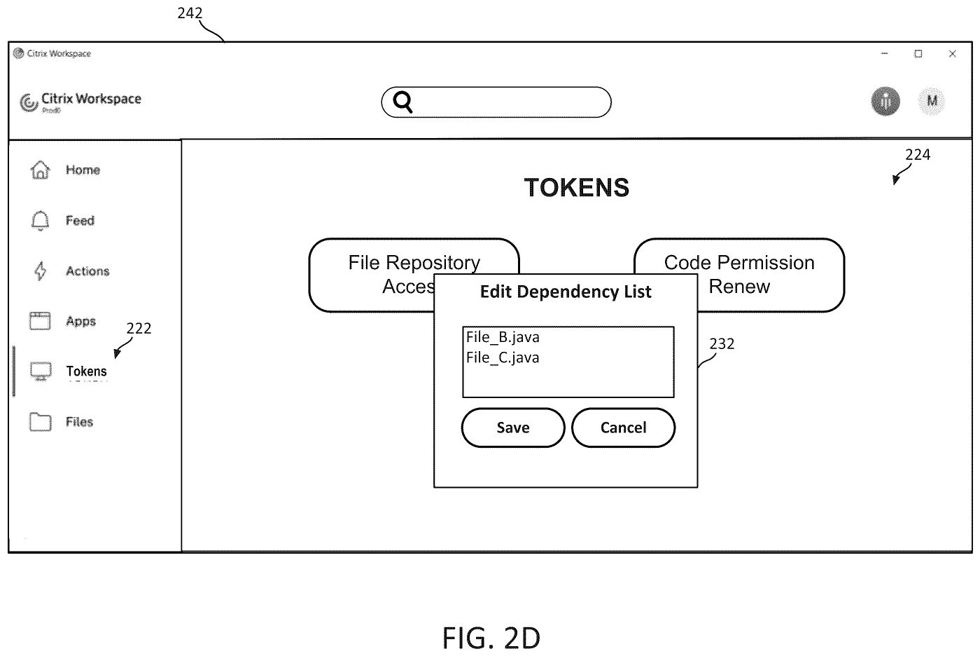

FIG. 2A, which is described in more detail below, shows a system 200 that may be identical to the system 100 shown in FIG. 1A, except that it includes a token playback engine 212, rather than the token recording engine 108. In some implementations, the token recording engine 108 and the token playback engine 212 may both be included within or operate in conjunction with the same base application, e.g., a specialized or enhanced browser, as described below.

The token recording engine 108 may take on any of numerous forms and may interact with an application for which the token is being generated in any of a number of ways. In some implementations, for example, the system 100 may be configured to create a token 118 for use by a browser 132, and the token recording engine 108 (as well as the token playback engine 212 described below in connection with FIG. 2A) may embodied within, or be an add-in or plug-in of, such a browser 132. Alternatively, the token recording engine 108 may interact with a browser 132 or other application in some other way, such through an application programming interface (API) of the application/browser 132 to enable the functionality described herein. The example scenarios described below relate to implementations in which the token 118 is generated by, and configured for use by, a specialized or enhanced browser 132. An example of a specialized browser, which may be embedded within a resource access application 622 (e.g., when the resource access application 622 is installed on the computing device) or provided by one of the resource feeds 604 (e.g., when the resource access application 622 is located remotely), e.g., via a secure browser service, is described below in Section E. Alternatively, a standard browser, e.g., a Google Chrome browser or a Mozilla Firefox browser, may be enhanced with an add-in or plug-in to perform the operations of the token recording engine 108 and/or the token playback engine 212.

As shown in FIG. 1A, in some implementations, the token recording engine 108 may be configured to execute a routine 150 for creating a new token 118 of the type noted above. The routine 150 may be implemented, for example, by one or more processors executing instructions encoded on one or more computer readable mediums. FIGS. 1B-1I show example GUI screens 160, 161, 162, 163, 164, 165, and 166 that may appear on the display 122 as the token recording engine 108 detects various user interface interactions (e.g., mouse clicks) corresponding to the browser 132 and records data representing certain of those interactions, as well as associated pixel data obtained from the screen buffer 120, for a sequence of steps that are to be represented in a new token 118.

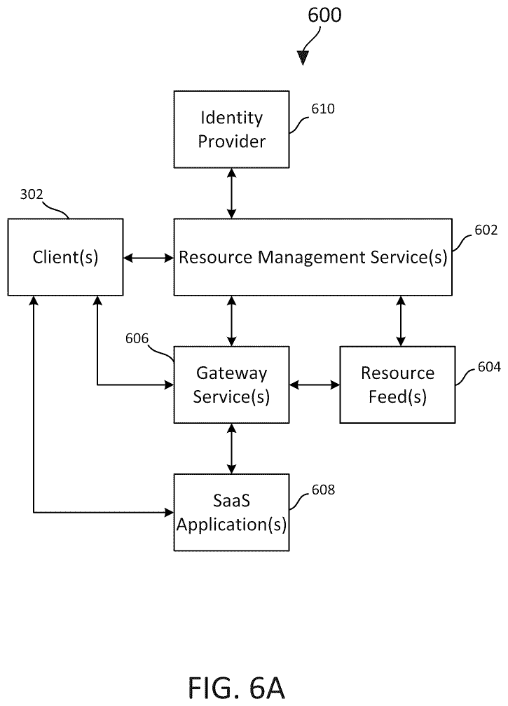

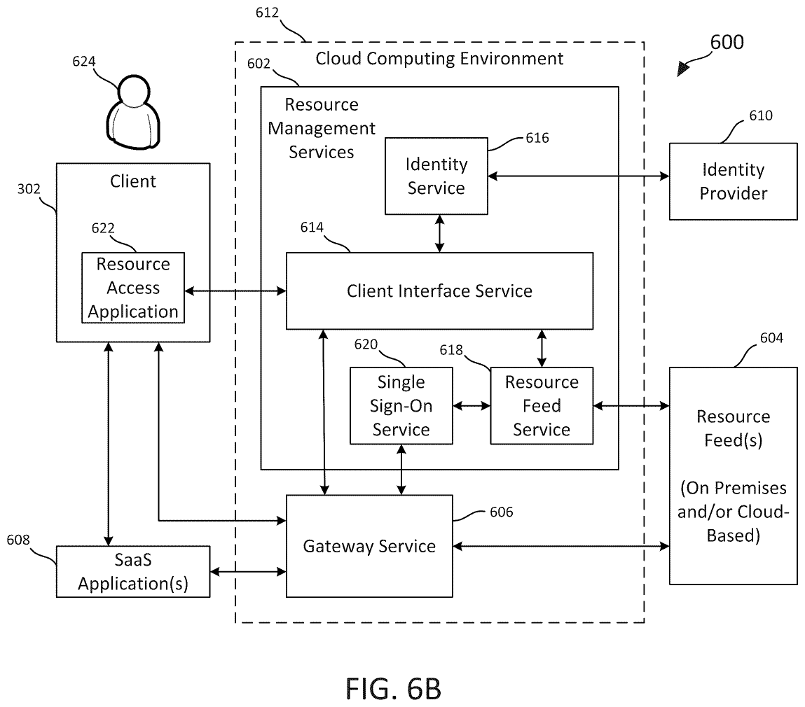

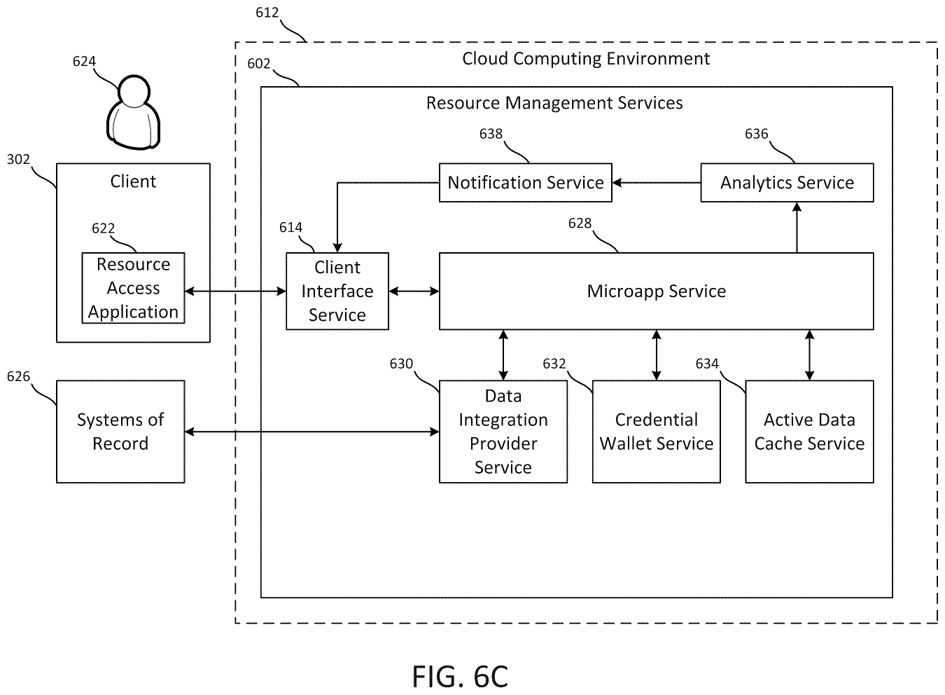

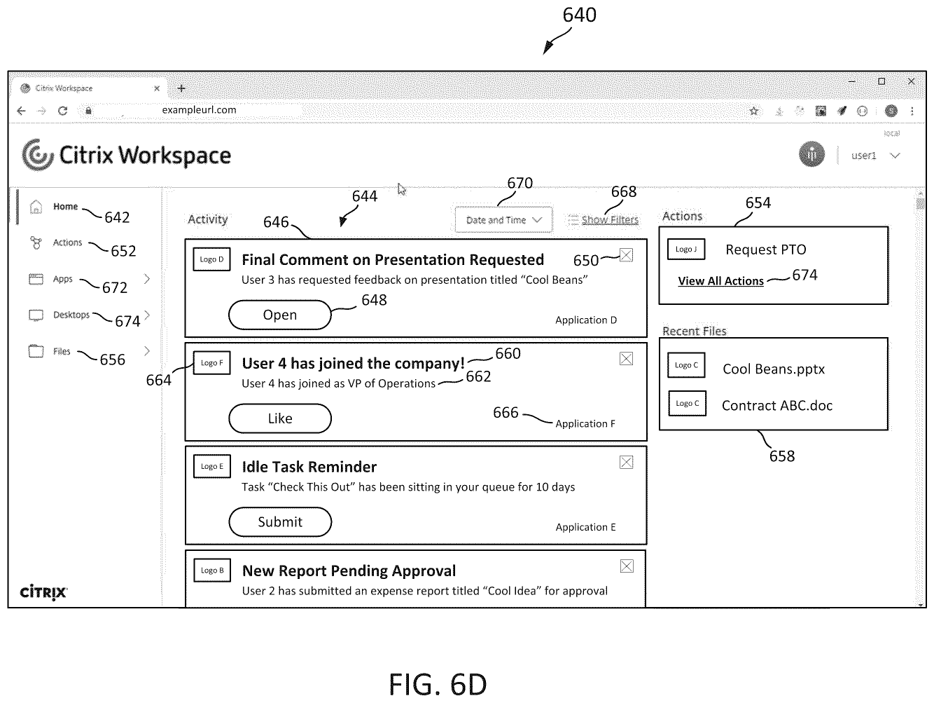

As shown in FIG. 1B, the display 122 (see FIG. 1A) may be presenting the screen 160 that includes a web page 136 that has been rendered by the browser 132. The browser 132 may be specialized and/or enhanced, as described above, to include the functionality of the token recording engine 108. In some implementations, for example, a user 102 may have launched the browser 132 via the resource access application 622, such as by selecting it from among a list of accessible applications revealed by selecting the “apps” user interface element 672 shown in FIG. 6D.

As also shown in FIG. 1B, the web browser 132 may additionally present a web page address bar 128 (populated with “http://example-repository” in the illustrated example) representing the uniform resource locator (URL) of the web page 136 currently displayed on the screen 160. In the illustrated example, the web page 136 corresponds to a file repository service. As shown, the web page 136 may include one or more selectable UI elements 134. A pointer 138 may be a graphical representation of user inputs, such as inputs received from a computer mouse connected to the client device 302 presenting the screen 160. Such a computer mouse may be used to navigate the pointer 138 about the screen 160 and to provide particular inputs, e.g., a left mouse click or a right mouse click, at various locations on the screen 160.

The token recording engine 108 may provide interface tools for a user 102 to record interactions with the displayed GUI (e.g., the web page 136). For example, as shown in FIG. 1C, the token recording engine 108 may be configured so that, in response to detecting a right mouse click, the browser 132 presents on the screen 161 one or more specialized options relating to token recording within an option menu 140. As illustrated, in addition to presenting common web page interface options, such as “back” and “forward,” in some implementations, the option menu 140 may include an option 142 to “start recording” or the like. Such an enhanced option menu 140, or the “start recording” option 142 in particular, may additionally or alternatively be accessed in various other ways, such as via a drop down menu, a selectable button, etc.

In some implementations, the user 102 may select the recording option 142 to begin recording a token 118 representing one or more one or more GUI interactions. As shown in FIG. 1D, upon selection of the recording option 142, in some implementations, the browser 132 may present a recording indicator 144 on the screen 162. As illustrated, the recording indicator 144 may include, for example, a small bar at the top of the screen 162 that displays the text “recording” or the like and/or a graphical element that signifies a recording is in process, such as a red dot. In some implementations, as an initial step of the recording process, the token recording engine 108 may record the URL presented in the web page address bar 128. As explained in more detail below, in some implementations, such a recorded URL may identify a “starting” web page to which a browser 132 is to navigate when the token 118 is subsequently executed by the token playback engine 212.

Referring again to FIG. 1A, in some implementations, the routine 150 performed by the token recording engine 108 may begin at a step 152, at which, in response to at least one first input (e.g., one or more user inputs 106) to a user interface (e.g., the web browser 132) of a computing system (e.g., a client device 302), the token recording engine 108 may determine that at least one action (e.g., a left mouse click to select a UI element selection) is to be taken with respect to a first UI element (e.g., the selectable UI element 134) being displayed by the user interface.

In some implementations, the at least one first input of the step 152 may include one or more initial user inputs 106, such as described above, in which the user 102 somehow indicates to the token recording engine 108 that a token recording process is to begin, e.g., by selecting the “start recording” option 142 shown in FIG. 1C, as well as an additional user input 106 (e.g., a left mouse click, a right mouse click, etc.) selecting the desired UI element, such as illustrated in FIG. 1D. In such an implementation, as explained in more detail below, after initiating the token recording process, the user 102 may simply interact with various UI elements displayed by the GUI one or more web pages in a desired manner (e.g., by left clicking on them right clicking on them, etc.), and the token recording engine 108 may record pixel data corresponding to such interactions, as well as the actions that are to be taken (e.g., left mouse clicks, right mouse clicks, etc.), for inclusion in the token 118, until the user 102 subsequently indicates to the token recording engine 108 that the token recording process is to cease.

In other implementations, the at least one first input of the step 152 may include one or more user inputs 106 to identify a specific action that is to be taken with respect to a UI element, e.g., the selectable UI element 134, without actually selecting the UI element. As shown in FIG. 1E, for example, a user 102 may provide a user input 106 (e.g., a left mouse click) selecting a UI element, e.g., the selectable UI element 134, for which a particular action is to be taken (e.g., a left mouse click), thereby causing the browser 132 to present a recording menu 146 of available “recording” actions on the screen 163, and may then select a “record click” option from the recording menu 146. In such implementations, the user 102 may iteratively identify particular actions that are to be taken with respect to specific UI elements on one more GUIs, without actually taking the indicated actions with respect to those UI elements. In at least some circumstances, however, it may be necessary for the user 102 to follow the identification of an action that is to be taken with respect to certain UI elements with a user input actually taking the indicated action (e.g., by left clicking on it) in order to continue the recording process, e.g., to retrieve a different web page including additional UI elements for which actions are to be recorded.

At step 154 of the routine 150, the token recording engine 108 may determine first pixel data corresponding to the first UI element, e.g., the selectable UI element 134 shown in FIGS. 1D and 1E. For example, as indicated by an arrow 110 in FIG. 1A, in some implementations, the token recording engine 108 may make a request for screen pixel data to the operating system 114, e.g., via one or more APIs of the operating system 114. In response, as illustrated, the operating system 114 may capture screen pixel data 112 of the screen buffer 120 and return that captured screen pixel data 112 to the token recording engine 108. The screen buffer 120 may include, for example, data representing color values for individual pixels to be shown on the display 122. Color values may be stored, for example, in 1-bit binary (monochrome), 4-bit palettized, 8-bit palettized, 16-bit high color, and 24-bit true color formats. An additional alpha channel may sometimes be used to retain information about pixel transparency.

The token recording engine 108 may use coordinate data of the user input 106 indicating where the specified action is to be taken (e.g., coordinates of the location of where a left mouse click is to occur) to identify a plurality of pixels in the immediate vicinity of the location. The token recording engine 108 may then record the color values and coordinates of the identified pixels. As shown in FIG. 1F, in some implementations, an area 148 may be determined on the screen 160 (also shown in FIG. 1B), such as based on a radius from the coordinates of the specified location at which the indicated action is to be taken, for selecting pixels. In some implementations, a parameter may be set for a minimum number of pixels, such as determining at least ten pixels within the area 148. The greater number of determined pixels for a given action may increase the precision during token playback, but may also slow down the execution of the token playback.

In some situations, a GUI for which a token 118 is being recorded may require a user 102 to select or input data, such as by selecting on option from a drop down list, or inputting text into a text field. For example, using the previous example of the user 102 checking out a file, for each iteration of the checkout process, the user 102 may be required to select a file name from a list. As shown in FIG. 1G, for instance, the browser 132 may present the screen 164 on which a file selection element 170 may provide a list of one or more file names, and the user 102 may need to select one or those file names. In such a situation, one or more user inputs 106 may be provided to indicate to the token recording engine 108 that a dependency list is to be referenced to determine items that are to be selected or entered during repeated iterations of a specified sequence of recorded actions. As shown in FIG. 1H, for example, a right mouse click on the file selection element 170 may cause the browser 132 to present a screen 165 including the recording menu 146 (also shown in FIG. 1E). As indicated, in some implementations, the recording menu 146 may further include an option to add a dependency. As described in more detail below, in response to selected the “add dependency” option, the token recording engine 108 may record data indicating that, during playback of the token 118, a dependency list is to be accessed to identify the next item on the list, such as a file name, and that the token playback engine 212 is to select or enter that item when performing the corresponding step.

The interface interactions shown in FIGS. 1D, 1E, and 1H may be performed by the user 102, as part of the recording process, for different selectable UI elements 134 and/or file selection elements 170 that encompass a repeatable process (e.g., the repeated file checkout process) until the end of the repeatable process is reached. As noted above, for the respective actions the user 102 indicates are to be taken with respect to a UI element of the GUI, the token recording engine 108 may record, as part of a token 118, both the action that is to be taken and pixel data for a plurality of pixels in a vicinity of the location at which the action is to be taken.

Upon reaching the end of the repeatable process, the user 102 may provide at least one input 106 to indicate to the token recording engine 108 that the token recording process is complete. For example, as shown in FIG. 1I, in some implementations, a user 102 may perform a right mouse click (or similar alternative input) to cause the browser to present the screen 166 including the recording menu 146 (also shown in FIGS. 1E and 1H), and may select an option to end the recording from that menu. A selection of the option to end the recording may send an indication to the token recording engine 108 to end the recording of user inputs 106 and to generate (as indicated by arrow 116 of FIG. 1A) a token 118 based on those inputs. In some implementations, the recording indicator 144 may be removed from the screen 166 or change the graphical element to indicate the recording has stopped.

At a step 156 of the routine 150 (shown in FIG. 1A), upon receiving the indication to end the recording, the token recording engine 108 may generate a script (e.g., a token 118) using the recorded data. As indicated, the script may be configured to cause a computing device (e.g., a client device 302) to (A) determine (e.g., by examining the current contents of the screen buffer 120) that first pixels corresponding to the first pixel data (e.g., the recorded screen pixel data 112) are displayed on a screen (e.g., display 122) of the computing device, and to (B) based on the first pixels corresponding to the first pixel data (e.g., the recorded screen pixel data 112), cause the computing device (e.g., the client device 302) to perform an action (e.g., mouse click) at coordinates corresponding to a location on the screen at which of the pixels are being displayed.

Upon selection of the option to end the recording from the recording menu 146, the token recording engine 108 may further present to the user 102 a prompt to provide a name for the token 118. The named token 118 may then be displayed on a token screen, such as shown in FIG. 2B. In some implementations, tokens generated in this fashion may be accessible via the resource access application 622 (described in Section E), such as by selecting the “tokens” UI element 222 show in FIG. 2B. In other implementations, the token recording engine 108 may prompt the user 102 to identify a location to which the newly-recorded token 118 is to be stored, such as within a particular folder on a client device 302, to a desktop of a client device 302, to a network storage location etc. The user 102 may thereafter send the token 118 to one or more other individuals, e.g., as an attachment to an email, so as to enable those individuals to execute the token using a token playback engine 212 on their respective machines.

If the token 118 included dependencies, then the user 102 may additionally be prompted to provide a dependency list. The dependency list may include, for example, one or more text inputs identifying items that are to be selected sequentially during repeated iterations of the step for which the dependency was specified. For the file selection element 170 shown in FIG. 1G, for example, a dependency list may include the file names “File_B.java” and “File_C.java”. When the file checkout token is executed, two iterations of certain steps of the file checkout token may occur, with the first iteration selecting “File_B.java” for checkout and the second iteration selecting “File_C.java” for checkout.

FIG. 2A shows an example system 200 configured to playback a token 118 for performing repeated actions using an application (e.g., a browser 132), in accordance with some embodiments. As noted above, the system 200 may be identical to the system 100 shown in FIG. 1A, except that it includes a token playback engine 212, rather than the token recording engine 108. Accordingly, similar to the system 100, in some implementations, the components of the system 200 shown in FIG. 2A may likewise be embodied by and/or operate in conjunction with a client device 302 (examples of which are described below in Sections B-E). Further, as also noted above, in some implementations, the token recording engine 108 and the token playback engine 212 may both be included within or operate in conjunction with the same base application, e.g., a specialized or enhanced browser.

Similar to the token recording engine 108, the token playback engine 212 may take on any of numerous forms and may interact with an application for which the token 118 was generated in any of a number of ways. In some implementations, for example, the system 200 may be configured to automate interactions with a GUI rendered by a browser 132, and may embodied within, or be an add-in or plug-in of, such a browser 132. Alternatively, the token playback engine 212 may interact with a browser 132 or other application in some other way, such through an application programming interface (API) of the application/browser to enable the functionality described herein. Like the example scenarios described above for the token recording engine 108, the example scenarios described below for the token playback engine 212 relate to implementations in which the token 118 is executed by a specialized or enhanced browser.

FIG. 2A shows an example routine 250 that may be executed by the token playback engine 212 to execute the operations defined by a token, such as the token 118 generated by the token recording engine 108. In some implementations, the operations performed by the token playback engine 212, including the routine 250, may be implemented by one or more processors executing instructions encoded on one or more computer readable mediums. FIGS. 2B and 2C show example screens 240 and 241, respectively, that may be presented on the display 122 of the system 200 to enable a user 102 to initiate execution of a token 118 by the token playback engine 212.

As shown in FIG. 2B, the display 122 (see FIG. 2A) of the computing device may present (as the screen 240) a GUI of the resource access application 622 (described in Section E). The resource access application 622 may include a “tokens” UI element 222 that, when selected, may present icons or other descriptors corresponding to previously generated tokens 118. In the illustrated example, the available tokens include a first token 118a for “file repository access” and a second token 118b for “code permission renew.” The user 102 may select a displayed token (e.g., the first token 118a or the second token 118b) for execution, such as by double clicking on it. As shown in FIG. 2A, selection of a token 118 in such a manner may trigger the communication of a token execution instruction 202 to the token playback engine 212. The token execution instruction may trigger the token playback engine 212 to begin executing the script defined by the token 118.

As shown in FIG. 2C, for tokens having defined dependencies, in some implementations, upon selection of the displayed token, the user 102 may be prompted via the screen 241 to select a dependency list for use with the token 118. In some implementations, such selection may be performed using a dependency list selection element 226. As shown, in some implementations, the dependency list selection element 226 may include an “edit” UI element 228 to edit a selected dependency list or add a new dependency list and an “execute” UI element 230 to execute the token 118 with the selected dependency list. As shown in FIG. 2D, in some implementations, if the “edit” UI element 228 (see FIG. 2C) is selected after a particular dependency list has been selected, the token playback engine 212 may cause the client device 302 to present a screen 242 that includes a dependency list editor 232. The user 102 may edit the dependency entries for the selected dependency list using the dependency list editor 232. If, on the other hand, the “edit” UI element 228 (see FIG. 2C) is selected without having first selected an identified dependency list, the token playback engine 212 may instead cause the client device 302 to present a tool for creating a new dependency list to add to the list of available dependency lists presented by the dependency list selection element 226. In response to the user 102 selecting the “execute” UI element 230 (see FIG. 2C), execution of the token may begin (using the selected dependency list), e.g., by communicating the token execution instruction 202 to the token playback engine 212 and accessing (as indicated by the arrow 214 of FIG. 2A) the token 118.

As shown in FIG. 2A, in some implementations, the routine 250 may begin at a step 252, at which the token playback engine 212 may determine that a script (e.g., the token 118) identifies first pixel data (e.g., stored screen pixel data 112) and at least one first action (e.g., left mouse click) associated with the first pixel data. As described in reference to FIG. 1A, the token 118 may include such data for each of a plurality of actions that are to be taken with respect to a GUI.

At a step 254 of the routine 250, the token playback engine 212 may determine (e.g., by evaluating pixel data captured from the screen buffer 120) that first pixels being presented on a screen of a computing device (e.g., the display 122) correspond to the first pixel data identified in the script. As indicated by an arrow 204 in FIG. 1A, in some implementations, the token playback engine 212 may request screen pixel data from the operating system 114 and, in response to such a request, the operating system 114 may capture screen pixel data 208 of the screen buffer 120, and then send that captured screen pixel data 208 to the token playback engine 212. The token playback engine 212 may then determine whether the captured screen pixel data 208 substantially matches the recorded pixel data for the current action step indicated by the script. The token playback engine 212 may, for example, determine whether a subset of the pixels represented in the captured screen pixel data 208 that have substantially the same color values and are separated by the substantially same relative distances. In some implementations, the token playback engine 212 may determine that the captured screen pixel data 208 substantially matches the recorded pixel data for the current action step when at least a threshold number of the captured pixels that are separated by the same relative distances as the recorded pixels are found have color values that are within a threshold level of similarity of the color values of the corresponding recorded pixels.

In some implementations, the coordinate data for the respective pixels of the recorded pixel data may be based on the Cartesian coordinate system, with the location of the desired interface interaction (e.g., a left mouse click) positioned at the origin. Thus, the token playback engine 212 may determine a match with the recorded pixel data if a group of pixels from the captured screen pixel data 208 are identified with the same color values and the same relative positions. For example, the recorded pixel data may include data for three pixels: (1) a first pixel with a first color value and relative coordinates of (3, 4), (2) a second pixel with a second color value and relative coordinates of (−2, 3), and (3) a third pixel with a third color value and relative coordinates of (4, −1). Continuing the example, the token playback engine 212 may determine a match for the recorded pixel data if, within the screen pixel data 208, three screen pixels are identified, where (1) a first screen pixel with the first color value is located at (153, 264), (2) a second screen pixel with the second color value is located at (148, 263), and (3) a third screen pixel with the third color value is located at (154, 259).

At a step 256 of the routine 250, based at least in part on the first pixels (i.e., captured screen pixel data 208) corresponding to the first pixel data (i.e., the recorded pixel data for the current action step indicated by the script) and the at least one first action (e.g., a left mouse click) being associated with the first pixel data in the script, the token playback engine 212 may cause the computing device (e.g., a client device 302) to take the at least one first action at coordinates corresponding to a location on screen (e.g., the display 122) at which of the first pixels are being displayed. As indicated by an arrow 210 in FIG. 2A, in some implementations, the token playback engine 212 may instruct the operating system 114 to perform at least one first action (e.g., invoke a left mouse click operation) at a location of the GUI corresponding to the location of the pixels of the screen pixel data 208 that matched to the step pixel data. As noted previously, in some implementations, such an action (e.g., a mouse click) may be invoked at a position relative to the matching pixels that is the same as the position of the step recording action (e.g., a mouse click the triggered the recording of the pixel data for the step) relative to recorded pixel data.

In some instances, as described in reference to FIGS. 1G and 1H, the token playback engine 212 may determine that the script indicates that a recorded UI interaction has a dependency. As described in reference to FIG. 2C, in such circumstances, the user 102 may select a dependency list when starting the token execution. The dependency list may include one or more entries corresponding to a particular interface interaction, such as selecting an entry from a list that may be performed for each item on the list. The token playback engine 212 may be configured to execute at least certain actions defined by the token 118 a number times that corresponds to the number of entries in the dependency list.

In some implementations, when the action identified in a step defined by the token 118 has a dependency, the token playback engine 212 may receive the captured screen pixel data 208 from the operating system 114 and perform optical character recognition (OCR) for the captured screen pixel data 208 to determine textual characters present in the captured screen pixel data 208. The token playback engine 212 may then determine if the text of the dependency list entry is found within the determined textual characters of the captured screen pixel data 208. If the dependency list entry is located within the determined textual characters, then the token playback engine 212 may send one or more instructions to the operating system 114 to invoke an action (e.g., a left mouse click) at a position corresponding to a location at which the determined textual characters corresponding to the dependency list entry were detected, thus effectively selecting an item on a selection list. The token playback engine 212 may then proceed to the next step represented by the token 118, such as selecting a UI element that executes a checkout process for a file name selected during the dependency step.

In some implementations, similar to the step 252, the token playback engine 212 may determine if the token 118 includes a second step based on identifying second recorded pixel data and at least one second action (e.g., a left mouse click) associated with the second recorded pixel data. If the token 118 includes such a second step, the token playback engine 212 may again perform the steps 254 and 256 of the routine 250, but with respect second recorded pixel data/second action for that second step. If, instead, the token playback engine 212 determines that the token 118 does not represent another step, the token playback engine 212 may cease executing the token 118.

Upon completion of the token execution, the token playback engine 212 may generate results for presentation on the display 122. The results of the token execution may indicate, for example, whether the token 118 executed successfully or failed, in whole or in part. If the token 118 included a dependency, then the results may indicate the success or failure for the respective dependencies of the dependency list.

### B. Network Environment

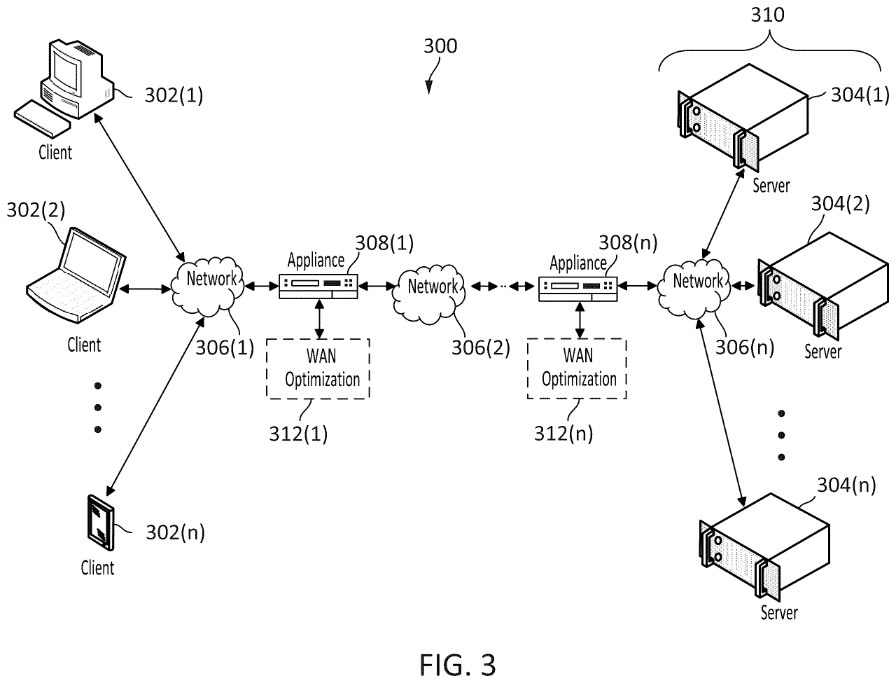

Referring to FIG. 3, an illustrative network environment 300 is depicted. As shown, the network environment 300 may include one or more clients 302(1)-302(n) (also generally referred to as local machine(s) 302 or client(s) 302) in communication with one or more servers 304(1)-304(n) (also generally referred to as remote machine(s) 304 or server(s) 304) via one or more networks 306(1)-306(n) (generally referred to as network(s) 306). In some embodiments, a client 302 may communicate with a server 304 via one or more appliances 308(1)-308(n) (generally referred to as appliance(s) 308 or gateway(s) 308). In some embodiments, a client 302 may have the capacity to function as both a client node seeking access to resources provided by a server 304 and as a server 304 providing access to hosted resources for other clients 302.

Although the embodiment shown in FIG. 3 shows one or more networks 306 between the clients 302 and the servers 304, in other embodiments, the clients 302 and the servers 304 may be on the same network 306. When multiple networks 306 are employed, the various networks 306 may be the same type of network or different types of networks. For example, in some embodiments, the networks 306(1) and 306(n) may be private networks such as local area network (LANs) or company Intranets, while the network 306(2) may be a public network, such as a metropolitan area network (MAN), wide area network (WAN), or the Internet. In other embodiments, one or both of the network 306(1) and the network 306(n), as well as the network 306(2), may be public networks. In yet other embodiments, all three of the network 306(1), the network 306(2) and the network 306(n) may be private networks. The networks 306 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 306 may include one or more mobile telephone networks that use various protocols to communicate among mobile devices. In some embodiments, the network(s) 306 may include one or more wireless local-area networks (WLANs). For short range communications within a WLAN, clients 302 may communicate using 802.11, Bluetooth, and/or Near Field Communication (NFC).

As shown in FIG. 3, one or more appliances 308 may be located at various points or in various communication paths of the network environment 300. For example, the appliance 308(1) may be deployed between the network 306(1) and the network 306(2), and the appliance 308(n) may be deployed between the network 306(2) and the network 306(n). In some embodiments, the appliances 308 may communicate with one another and work in conjunction to, for example, accelerate network traffic between the clients 302 and the servers 304. In some embodiments, appliances 308 may act as a gateway between two or more networks. In other embodiments, one or more of the appliances 308 may instead be implemented in conjunction with or as part of a single one of the clients 302 or servers 304 to allow such device to connect directly to one of the networks 306. In some embodiments, one or more appliances 308 may operate as an application delivery controller (ADC) to provide one or more of the clients 302 with access to business applications and other data deployed in a datacenter, the cloud, or delivered as Software as a Service (SaaS) across a range of client devices, and/or provide other functionality such as load balancing, etc. In some embodiments, one or more of the appliances 308 may be implemented as network devices sold by Citrix Systems, Inc., of Fort Lauderdale, FL, such as Citrix Gateway™ or Citrix ADC™.

A server 304 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 304 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 304 may execute a remote presentation services program or other program that uses a thin-client or a remote-display protocol to capture display output generated by an application executing on a server 304 and transmit the application display output to a client device 302.

In yet other embodiments, a server 304 may execute a virtual machine providing, to a user of a client 302, access to a computing environment. The client 302 may be a virtual machine. The virtual machine may be managed by, for example, a hypervisor, a virtual machine manager (VMM), or any other hardware virtualization technique within the server 304.

As shown in FIG. 3, in some embodiments, groups of the servers 304 may operate as one or more server farms 310. The servers 304 of such server farms 310 may be logically grouped, and may either be geographically co-located (e.g., on premises) or geographically dispersed (e.g., cloud based) from the clients 302 and/or other servers 304. In some embodiments, two or more server farms 310 may communicate with one another, e.g., via respective appliances 308 connected to the network 306(2), to allow multiple server-based processes to interact with one another.

As also shown in FIG. 3, in some embodiments, one or more of the appliances 308 may include, be replaced by, or be in communication with, one or more additional appliances, such as WAN optimization appliances 312(1)-312(n), referred to generally as WAN optimization appliance(s) 312. For example, WAN optimization appliances 312 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 312 may be a performance enhancing proxy or a WAN optimization controller.

In some embodiments, one or more of the appliances 308, 312 may be implemented as products sold by Citrix Systems, Inc., of Fort Lauderdale, FL, such as Citrix SD-WAN™ or Citrix Cloud™. For example, in some implementations, one or more of the appliances 308, 312 may be cloud connectors that enable communications to be exchanged between resources within a cloud computing environment and resources outside such an environment, e.g., resources hosted within a data center of + an organization.

### C. Computing Environment

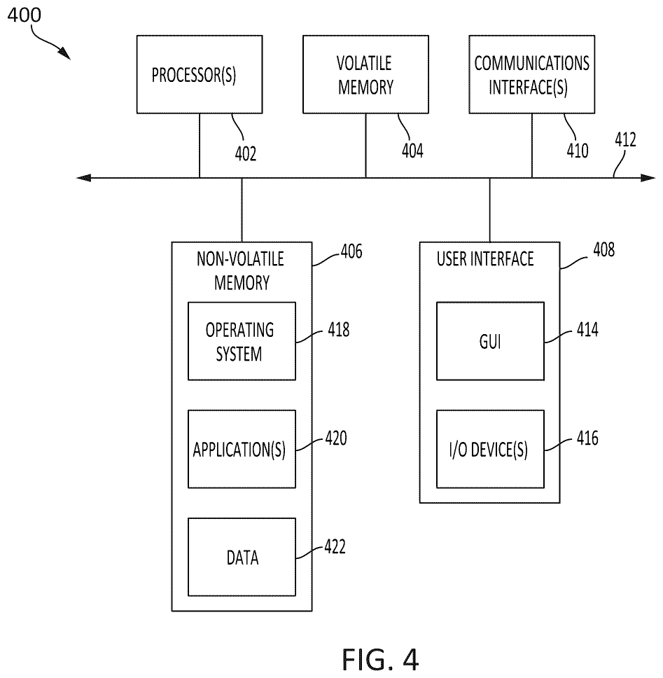

FIG. 4 illustrates an example of a computing system 400 that may be used to implement one or more of the respective components (e.g., the clients 302, the servers 304, the appliances 308, 312, etc.) within the network environment 300 shown in FIG. 3. As shown in FIG. 4, the computing system 400 may include one or more processors 402, volatile memory 404 (e.g., RAM), non-volatile memory 406 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 408, one or more communications interfaces 410, and a communication bus 412. The user interface 408 may include a graphical user interface (GUI) 414 (e.g., a touchscreen, a display, etc.) and one or more input/output (I/O) devices 416 (e.g., a mouse, a keyboard, etc.). The non-volatile memory 406 may store an operating system 418, one or more applications 420, and data 422 such that, for example, computer instructions of the operating system 418 and/or applications 420 are executed by the processor(s) 402 out of the volatile memory 404. Data may be entered using an input device of the GUI 414 or received from I/O device(s) 416. Various elements of the computing system 400 may communicate via communication with the bus 412. The computing system 400 as shown in FIG. 4 is shown merely as an example, as the clients 302, servers 304 and/or appliances 308 and 312 may be implemented by any computing or processing environment and with any type of machine or set of machines that may have suitable hardware and/or software capable of operating as described herein.

The processor(s) 402 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 410 may include one or more interfaces to enable the computing system 400 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 400 may execute an application on behalf of a user of a client computing device (e.g., a client 302 shown in FIG. 3), may execute a virtual machine, which provides an execution session within which applications execute on behalf of a user or a client computing device (e.g., a client 302 shown in FIG. 3), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

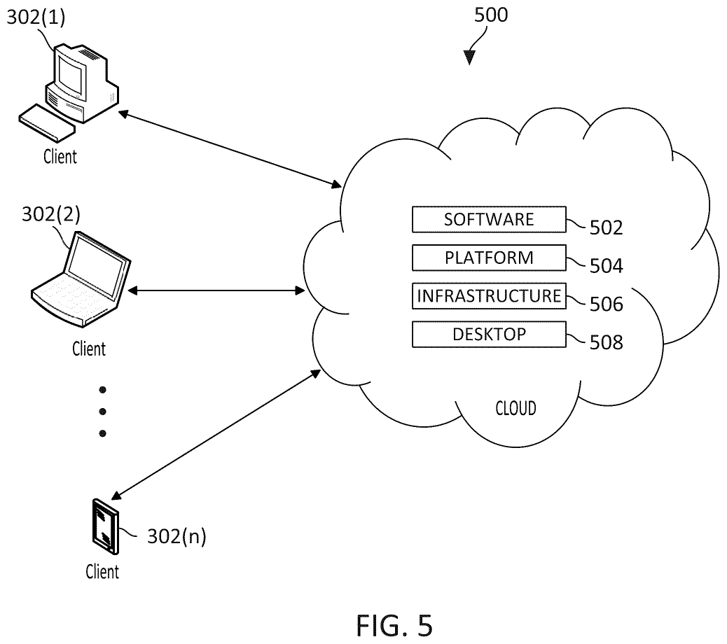

Referring to FIG. 5, a cloud computing environment 500 is depicted, which may also be referred to as a cloud environment, cloud computing or cloud network. The cloud computing environment 500 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 500, one or more clients 302 (such as those described in connection with FIG. 3) are in communication with a cloud network 504. The cloud network 504 may include back-end platforms, e.g., servers, storage, server farms and/or data centers. The clients 302 may correspond to a single organization/tenant or multiple organizations/tenants. More particularly, in one example implementation, the cloud computing environment 500 may provide a private cloud serving a single organization (e.g., enterprise cloud). In another example, the cloud computing environment 500 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 500 may provide a hybrid cloud that is a combination of a public cloud and one or more resources located outside such a cloud, such as resources hosted within one or more data centers of an organization. Public clouds may include public servers that are maintained by third parties to the clients 302 or the enterprise/tenant. The servers may be located off-site in remote geographical locations or otherwise. In some implementations, one or more cloud connectors may be used to facilitate the exchange of communications between one more resources within the cloud computing environment 500 and one or more resources outside of such an environment.

The cloud computing environment 500 can provide resource pooling to serve multiple users via clients 302 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 500 can provide on-demand self-service to unilaterally provision computing capabilities (e.g., server time, network storage) across a network for multiple clients 302. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 500 can provide an elasticity to dynamically scale out or scale in response to different demands from one or more clients 302. In some embodiments, the cloud computing environment 500 may include or provide monitoring services to monitor, control and/or generate reports corresponding to the provided shared services and resources.

In some embodiments, the cloud computing environment 500 may provide cloud-based delivery of different types of cloud computing services, such as Software as a service (SaaS) 502, Platform as a Service (PaaS) 504, Infrastructure as a Service (IaaS) 506, and Desktop as a Service (DaaS) 508, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS platforms include AMAZON WEB SERVICES provided by Amazon.com, Inc., of Seattle, Washington, Azure IaaS provided by Microsoft Corporation or Redmond, Washington, RACKSPACE CLOUD provided by Rackspace US, Inc., of San Antonio, Texas, Google Compute Engine provided by Google Inc., of Mountain View, California, and RIGHTSCALE provided by RightScale, Inc., of Santa Barbara, California.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc., of San Francisco, California.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc., of San Francisco, California, or OFFICE 365 provided by Microsoft Corporation. Examples of SaaS may also include data storage providers, e.g. Citrix ShareFile® from Citrix Systems, DROPBOX provided by Dropbox, Inc., of San Francisco, California, Microsoft SKYDRIVE provided by Microsoft Corporation, Google Drive provided by Google Inc., or Apple ICLOUD provided by Apple Inc., of Cupertino, California.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Washington, or AMAZON WEB SERVICES provided by Amazon.com, Inc., of Seattle, Washington, for example. In the case of Citrix Cloud, Citrix Workspace app may be used as a single-entry point for bringing apps, files and desktops together (whether on-premises or in the cloud) to deliver a unified experience.

### E. Systems and Methods for Managing and Streamlining Access by Client Devices to a Variety of Resources

FIG. 6A is a block diagram of an example multi-resource access system 600 in which one or more resource management services 602 may manage and streamline access by one or more clients 302 to one or more resource feeds 604 (via one or more gateway services 606) and/or one or more software-as-a-service (SaaS) applications 608. In particular, the resource management service(s) 602 may employ an identity provider 610 to authenticate the identity of a user of a client 302 and, following authentication, identify one of more resources the user is authorized to access. In response to the user selecting one of the identified resources, the resource management service(s) 602 may send appropriate access credentials to the requesting client 302, and the client 302 may then use those credentials to access the selected resource. For the resource feed(s) 604, the client 302 may use the supplied credentials to access the selected resource via a gateway service 606. For the SaaS application(s) 608, the client 302 may use the credentials to access the selected application directly.

The client(s) 302 may be any type of computing devices capable of accessing the resource feed(s) 604 and/or the SaaS application(s) 608, and may, for example, include a variety of desktop or laptop computers, smartphones, tablets, etc. The resource feed(s) 604 may include any of numerous resource types and may be provided from any of numerous locations. In some embodiments, for example, the resource feed(s) 604 may include one or more systems or services for providing virtual applications and/or desktops to the client(s) 302, one or more file repositories and/or file sharing systems, one or more secure browser services, one or more access control services for the SaaS applications 608, one or more management services for local applications on the client(s) 302, one or more internet enabled devices or sensors, etc. The resource management service(s) 602, the resource feed(s) 604, the gateway service(s) 606, the SaaS application(s) 608, and the identity provider 610 may be located within an on-premises data center of an organization for which the multi-resource access system 600 is deployed, within one or more cloud computing environments, or elsewhere.

FIG. 6B is a block diagram showing an example implementation of the multi-resource access system 600 shown in FIG. 6A in which various resource management services 602 as well as a gateway service 606 are located within a cloud computing environment 612. The cloud computing environment may, for example, include Microsoft Azure Cloud, Amazon Web Services, Google Cloud, or IBM Cloud. It should be appreciated, however, that in other implementations, one or more (or all) of the components of the resource management services 602 and/or the gateway service 606 may alternatively be located outside the cloud computing environment 612, such as within a data center hosted by an organization.

For any of the illustrated components (other than the client 302) that are not based within the cloud computing environment 612, cloud connectors (not shown in FIG. 6B) may be used to interface those components with the cloud computing environment 612. Such cloud connectors may, for example, run on Windows Server instances and/or Linux Server instances hosted in resource locations and may create a reverse proxy to route traffic between those resource locations and the cloud computing environment 612. In the illustrated example, the cloud-based resource management services 602 include a client interface service 614, an identity service 616, a resource feed service 618, and a single sign-on service 620. As shown, in some embodiments, the client 302 may use a resource access application 622 to communicate with the client interface service 614 as well as to present a user interface on the client 302 that a user 624 can operate to access the resource feed(s) 604 and/or the SaaS application(s) 608. The resource access application 622 may either be installed on the client 302, or may be executed by the client interface service 614 (or elsewhere in the multi-resource access system 600) and accessed using a web browser (not shown in FIG. 6B) on the client 302.

As explained in more detail below, in some embodiments, the resource access application 622 and associated components may provide the user 624 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 622 is launched or otherwise accessed by the user 624, the client interface service 614 may send a sign-on request to the identity service 616. In some embodiments, the identity provider 610 may be located on the premises of the organization for which the multi-resource access system 600 is deployed. The identity provider 610 may, for example, correspond to an on-premises Windows Active Directory. In such embodiments, the identity provider 610 may be connected to the cloud-based identity service 616 using a cloud connector (not shown in FIG. 6B), as described above. Upon receiving a sign-on request, the identity service 616 may cause the resource access application 622 (via the client interface service 614) to prompt the user 624 for the user's authentication credentials (e.g., username and password). Upon receiving the user's authentication credentials, the client interface service 614 may pass the credentials along to the identity service 616, and the identity service 616 may, in turn, forward them to the identity provider 610 for authentication, for example, by comparing them against an Active Directory domain. Once the identity service 616 receives confirmation from the identity provider 610 that the user's identity has been properly authenticated, the client interface service 614 may send a request to the resource feed service 618 for a list of subscribed resources for the user 624.

In other embodiments (not illustrated in FIG. 6B), the identity provider 610 may be a cloud-based identity service, such as a Microsoft Azure Active Directory. In such embodiments, upon receiving a sign-on request from the client interface service 614, the identity service 616 may, via the client interface service 614, cause the client 302 to be redirected to the cloud-based identity service to complete an authentication process. The cloud-based identity service may then cause the client 302 to prompt the user 624 to enter the user's authentication credentials. Upon determining the user's identity has been properly authenticated, the cloud-based identity service may send a message to the resource access application 622 indicating the authentication attempt was successful, and the resource access application 622 may then inform the client interface service 614 of the successfully authentication. Once the identity service 616 receives confirmation from the client interface service 614 that the user's identity has been properly authenticated, the client interface service 614 may send a request to the resource feed service 618 for a list of subscribed resources for the user 624.

The resource feed service 618 may request identity tokens for configured resources from the single sign-on service 620. The resource feed service 618 may then pass the feed-specific identity tokens it receives to the points of authentication for the respective resource feeds 604. The resource feeds 604 may then respond with lists of resources configured for the respective identities. The resource feed service 618 may then aggregate all items from the different feeds and forward them to the client interface service 614, which may cause the resource access application 622 to present a list of available resources on a user interface of the client 302. The list of available resources may, for example, be presented on the user interface of the client 302 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 302, and/or one or more SaaS applications 608 to which the user 624 has subscribed). The lists of local applications and the SaaS applications 608 may, for example, be supplied by resource feeds 604 for respective services that manage which such applications are to be made available to the user 624 via the resource access application 622. Examples of SaaS applications 608 that may be managed and accessed as described herein include Microsoft Office 365 applications, SAP SaaS applications, Workday applications, etc.

For resources other than local applications and the SaaS application(s) 608, upon the user 624 selecting one of the listed available resources, the resource access application 622 may cause the client interface service 614 to forward a request for the specified resource to the resource feed service 618. In response to receiving such a request, the resource feed service 618 may request an identity token for the corresponding feed from the single sign-on service 620. The resource feed service 618 may then pass the identity token received from the single sign-on service 620 to the client interface service 614 where a launch ticket for the resource may be generated and sent to the resource access application 622. Upon receiving the launch ticket, the resource access application 622 may initiate a secure session to the gateway service 606 and present the launch ticket. When the gateway service 606 is presented with the launch ticket, it may initiate a secure session to the appropriate resource feed and present the identity token to that feed to seamlessly authenticate the user 624. Once the session initializes, the client 302 may proceed to access the selected resource.

When the user 624 selects a local application, the resource access application 622 may cause the selected local application to launch on the client 302. When the user 624 selects a SaaS application 608, the resource access application 622 may cause the client interface service 614 to request a one-time uniform resource locator (URL) from the gateway service 606 as well a preferred browser for use in accessing the SaaS application 608. After the gateway service 606 returns the one-time URL and identifies the preferred browser, the client interface service 614 may pass that information along to the resource access application 622. The client 302 may then launch the identified browser and initiate a connection to the gateway service 606. The gateway service 606 may then request an assertion from the single sign-on service 620. Upon receiving the assertion, the gateway service 606 may cause the identified browser on the client 302 to be redirected to the logon page for identified SaaS application 608 and present the assertion. The SaaS may then contact the gateway service 606 to validate the assertion and authenticate the user 624. Once the user has been authenticated, communication may occur directly between the identified browser and the selected SaaS application 608, thus allowing the user 624 to use the client 302 to access the selected SaaS application 608.

In some embodiments, the preferred browser identified by the gateway service 606 may be a specialized browser embedded in the resource access application 622 (when the resource access application 622 is installed on the client 302) or provided by one of the resource feeds 604 (when the resource access application 622 is located remotely), e.g., via a secure browser service. In such embodiments, the SaaS applications 608 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 302 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 604) for assessment of its security risk by a web filtering service. For approved URLs, the specialized browser may be permitted to access the link. For suspicious links, however, the web filtering service may have the client interface service 614 send the link to a secure browser service, which may start a new virtual browser session with the client 302, and thus allow the user to access the potentially harmful linked content in a safe environment.

In some embodiments, in addition to or in lieu of providing the user 624 with a list of resources that are available to be accessed individually, as described above, the user 624 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources-SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user-interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 302 to notify a user 624 of something that requires the user's attention (e.g., approval of an expense report, new course available for registration, etc.).

FIG. 6C is a block diagram similar to that shown in FIG. 6B but in which the available resources (e.g., SaaS applications, web applications, Windows applications, Linux applications, desktops, file repositories and/or file sharing systems, and other data) are represented by a single box labeled “systems of record,” and further in which several different services are included within the resource management services block 602. As explained below, the services shown in FIG. 6C may enable the provision of a streamlined resource activity feed and/or notification process for a client 302. In the example shown, in addition to the client interface service 614 discussed above, the illustrated services include a microapp service 628, a data integration provider service 630, a credential wallet service 632, an active data cache service 634, an analytics service 636, and a notification service 638. In various embodiments, the services shown in FIG. 6C may be employed either in addition to or instead of the different services shown in FIG. 6B. Further, as noted above in connection with FIG. 6B, it should be appreciated that, in other implementations, one or more (or all) of the components of the resource management services 602 shown in FIG. 6C may alternatively be located outside the cloud computing environment 612, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 622 without having to launch the native application. The system shown in FIG. 6C may, for example, aggregate relevant notifications, tasks, and insights, and thereby give the user 624 a dynamic productivity tool. In some embodiments, the resource activity feed may be intelligently populated by utilizing machine learning and artificial intelligence (AI) algorithms. Further, in some implementations, microapps may be configured within the cloud computing environment 612, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 6C, the systems of record 626 may represent the applications and/or other resources the resource management services 602 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 602, and in particular the data integration provider service 630, may, for example, support REST API, JSON, OData-JSON, and 6ML. As explained in more detail below, the data integration provider service 630 may also write back to the systems of record, for example, using OAuth2 or a service account.

In some embodiments, the microapp service 628 may be a single-tenant service responsible for creating the microapps. The microapp service 628 may send raw events, pulled from the systems of record 626, to the analytics service 636 for processing. The microapp service may, for example, periodically cause active data to be pulled from the systems of record 626.

In some embodiments, the active data cache service 634 may be single-tenant and may store all configuration information and microapp data. It may, for example, utilize a per-tenant database encryption key and per-tenant database credentials.

In some embodiments, the credential wallet service 632 may store encrypted service credentials for the systems of record 626 and user OAuth2 tokens.

In some embodiments, the data integration provider service 630 may interact with the systems of record 626 to decrypt end-user credentials and write back actions to the systems of record 626 under the identity of the end-user. The write-back actions may, for example, utilize a user's actual account to ensure all actions performed are compliant with data policies of the application or other resource being interacted with.

In some embodiments, the analytics service 636 may process the raw events received from the microapp service 628 to create targeted scored notifications and send such notifications to the notification service 638.

Finally, in some embodiments, the notification service 638 may process any notifications it receives from the analytics service 636. In some implementations, the notification service 638 may store the notifications in a database to be later served in an activity feed. In other embodiments, the notification service 638 may additionally or alternatively send the notifications out immediately to the client 302 as a push notification to the user 624.

In some embodiments, a process for synchronizing with the systems of record 626 and generating notifications may operate as follows. The microapp service 628 may retrieve encrypted service account credentials for the systems of record 626 from the credential wallet service 632 and request a sync with the data integration provider service 630. The data integration provider service 630 may then decrypt the service account credentials and use those credentials to retrieve data from the systems of record 626. The data integration provider service 630 may then stream the retrieved data to the microapp service 628. The microapp service 628 may store the received systems of record data in the active data cache service 634 and also send raw events to the analytics service 636. The analytics service 636 may create targeted scored notifications and send such notifications to the notification service 638. The notification service 638 may store the notifications in a database to be later served in an activity feed and/or may send the notifications out immediately to the client 302 as a push notification to the user 624.

In some embodiments, a process for processing a user-initiated action via a microapp may operate as follows. The client 302 may receive data from the microapp service 628 (via the client interface service 614) to render information corresponding to the microapp. The microapp service 628 may receive data from the active data cache service 634 to support that rendering. The user 624 may invoke an action from the microapp, causing the resource access application 622 to send an action request to the microapp service 628 (via the client interface service 614). The microapp service 628 may then retrieve from the credential wallet service 632 an encrypted Oauth2 token for the system of record for which the action is to be invoked, and may send the action to the data integration provider service 630 together with the encrypted OAuth2 token. The data integration provider service 630 may then decrypt the OAuth2 token and write the action to the appropriate system of record under the identity of the user 624. The data integration provider service 630 may then read back changed data from the written-to system of record and send that changed data to the microapp service 628. The microapp service 628 may then update the active data cache service 634 with the updated data and cause a message to be sent to the resource access application 622 (via the client interface service 614) notifying the user 624 that the action was successfully completed.

In some embodiments, in addition to or in lieu of the functionality described above, the resource management services 602 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 602 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 602 may, for example, parse these requests and respond because they are integrated with multiple systems on the back-end. In some embodiments, users may be able to interact with the virtual assistant through either the resource access application 622 or directly from another resource, such as Microsoft Teams. This feature may allow employees to work efficiently, stay organized, and deliver only the specific information they're looking for.

FIG. 6D shows how a display screen 640 presented by a resource access application 622 (shown in FIG. 6C) may appear when an intelligent activity feed feature is employed and a user is logged on to the system. Such a screen may be provided, for example, when the user clicks on or otherwise selects a “home” user interface element 642. As shown, an activity feed 644 may be presented on the screen 640 that includes a plurality of notifications 646 about respective events that occurred within various applications to which the user has access rights. An example implementation of a system capable of providing an activity feed 644 like that shown is described above in connection with FIG. 6C. As explained above, a user's authentication credentials may be used to gain access to various systems of record (e.g., SalesForce, Ariba, Concur, RightSignature, etc.) with which the user has accounts, and events that occur within such systems of record may be evaluated to generate notifications 646 to the user concerning actions that the user can take relating to such events. As shown in FIG. 6D, in some implementations, the notifications 646 may include a title 660 and a body 662, and may also include a logo 664 and/or a name 666 of the system of record to which the notification 646 corresponds, thus helping the user understand the proper context with which to decide how best to respond to the notification 646. In some implementations, one or more filters may be used to control the types, date ranges, etc., of the notifications 646 that are presented in the activity feed 644. The filters that can be used for this purpose may be revealed, for example, by clicking on or otherwise selecting the “show filters” user interface element 668. Further, in some embodiments, a user interface element 670 may additionally or alternatively be employed to select a manner in which the notifications 646 are sorted within the activity feed. In some implementations, for example, the notifications 646 may be sorted in accordance with the “date and time” they were created (as shown for the element 670 in FIG. 6D), a “relevancy” mode (not illustrated) may be selected (e.g., using the element 670) in which the notifications may be sorted based on relevancy scores assigned to them by the analytics service 636, and/or an “application” mode (not illustrated) may be selected (e.g., using the element 670) in which the notifications 646 may be sorted by application type.

When presented with such an activity feed 644, the user may respond to the notifications 646 by clicking on or otherwise selecting a corresponding action element 648 (e.g., “Approve,” “Reject,” “Open,” “Like,” “Submit,” etc.), or else by dismissing the notification, e.g., by clicking on or otherwise selecting a “close” element 650. As explained in connection with FIG. 6C below, the notifications 646 and corresponding action elements 648 may be implemented, for example, using “microapps” that can read and/or write data to systems of record using application programming interface (API) functions or the like, rather than by performing full launches of the applications for such systems of record. In some implementations, a user may additionally or alternatively view additional details concerning the event that triggered the notification and/or may access additional functionality enabled by the microapp corresponding to the notification 646 (e.g., in a separate, pop-up window corresponding to the microapp) by clicking on or otherwise selecting a portion of the notification 646 other than one of the user interface elements 648, 650. In some embodiments, the user may additionally or alternatively be able to select a user interface element either within the notification 646 or within a separate window corresponding to the microapp that allows the user to launch the native application to which the notification relates and respond to the event that prompted the notification via that native application rather than via the microapp.

In addition to the event-driven actions accessible via the action elements 648 in the notifications 646, a user may alternatively initiate microapp actions by selecting a desired action, e.g., via a drop-down menu accessible using the “action” user interface element 652 or by selecting a desired action from a list 654 of available microapp actions. In some implementations, the various microapp actions available to the user 624 logged onto the multi-resource access system 600 may be enumerated to the resource access application 622, e.g., when the user 624 initially accesses the system 600, and the list 654 may include a subset of those available microapp actions. The available microapp actions may, for example, be organized alphabetically based on the names assigned to the actions, and the list 654 may simply include the first several (e.g., the first four) microapp actions in the alphabetical order. In other implementations, the list 654 may alternatively include a subset of the available microapp actions that were most recently or most commonly accessed by the user 624, or that are preassigned by a system administrator or based on some other criteria. The user 624 may also access a complete set of available microapp actions, in a similar manner as the “action” user interface element 652, by clicking on the “view all actions” user interface element 674.

As shown, additional resources may also be accessed through the screen 640 by clicking on or otherwise selecting one or more other user interface elements that may be presented on the screen. For example, in some embodiments, the user may also access files (e.g., via a Citrix ShareFile® platform) by selecting a desired file, e.g., via a drop-down menu accessible using the “files” user interface element 656 or by selecting a desired file from a list 658 of recently and/or commonly used files. Further, in some embodiments, one or more applications may additionally or alternatively be accessible (e.g., via a Citrix Virtual Apps and Desktops™ service) by clicking on or otherwise selecting an “apps” user interface element 672 to reveal a list of accessible applications or by selecting a desired application from a list (not shown in FIG. 6D but similar to the list 658) of recently and/or commonly used applications. And still further, in some implementations, one or more desktops may additionally or alternatively be accessed (e.g., via a Citrix Virtual Apps and Desktops™ service) by clicking on or otherwise selecting a “desktops” user interface element 674 to reveal a list of accessible desktops or by or by selecting a desired desktop from a list (not shown in FIG. 6D but similar to the list 658) of recently and/or commonly used desktops.

The activity feed shown in FIG. 6D provides significant benefits, as it allows a user to respond to application-specific events generated by disparate systems of record without needing to navigate to, launch, and interface with multiple different native applications.

### F. Detailed Description of Example Embodiments of the System for Automation of User Operations Introduced in Section A

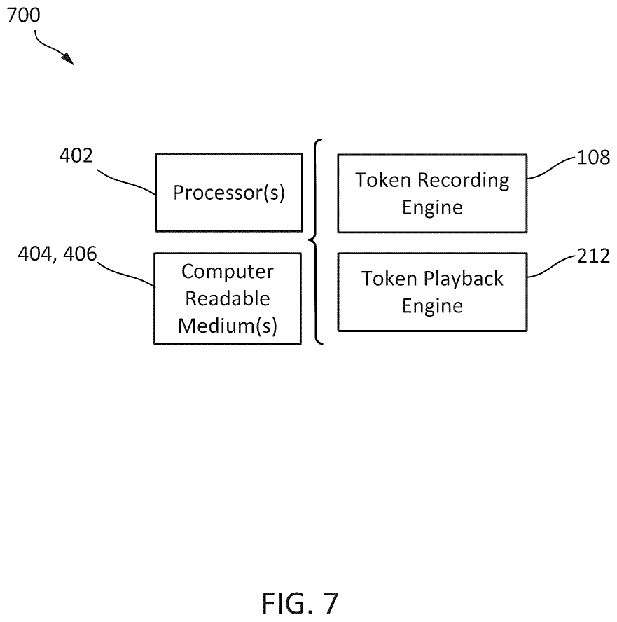

FIG. 7 shows example components 700 that may be included in the system 100 and the system 200 that are shown in FIGS. 1A and 2A, respectively. As shown in FIG. 7, in some implementations, the system 100 and the system 200 may include one or more processors 402 (see FIG. 4) and one or more computer readable mediums 404, 406 that may be encoded with instructions which, when executed by the processor(s) 402 may implement the functionality of the token recording engine 108 and the token playback engine 212 (described above).

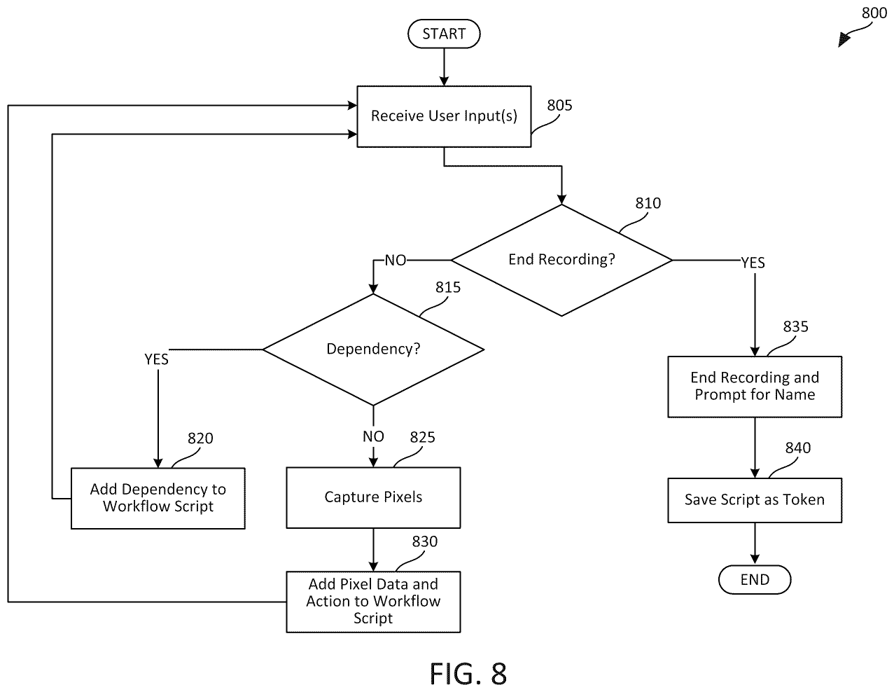

FIG. 8 illustrates an example routine 800 that may be performed by the token recording engine 108 for recording a token 118, in accordance with some embodiments. As noted above, in some implementations, the token recording engine 108 may be included within or operate in conjunction with a specialized or enhanced browser. As explained in more detail below, the routine 800 may be responsible for recording user interface interactions to generate a token workflow of the token 118.

In some implementations, the token recording process of the routine 800 may be initiated by the user 102 indicating to the token recording engine 108 that a token recording process is to begin, e.g., by selecting the “start recording” option 142 shown in FIG. 1C. In some implementations, as an initial step of the recording process, the token recording engine 108 may record the URL presented in the web page address bar 128 of the web browser 132. In some implementations, such a recorded URL may identify a “starting” web page to which a browser 132 is to navigate when the token 118 is subsequently executed by the token playback engine 212.

As shown in FIG. 8, after starting the token recording process, at a step 805 of the routine 800, the token recording engine 108 may receive one or more user inputs 106. In some cases, as shown in FIG. 1D, such a user input 106 may be a left mouse click. In other cases, as shown in FIG. 1E, the user 102 may provide an alternate input, such as a right mouse click, that displays the recording menu 146. The user 102 may then select an option (e.g., “record click,” “add dependency,” etc.) from the recording menu 146 that is then provided as the user input 106 for the step 805.

At a decision 810 of the routine 800, the token recording engine 108 may determine if the received user input 106 indicates to stop the token recording. If the user input 106 is not an indication to stop the token recording, then, at a decision 815, the token recording engine 108 may determine if the user input 106 indicates a dependency for the specified action. For example, as shown in FIG. 1H, the “add dependency” option may be selected from the recording menu 146 as the specified action.

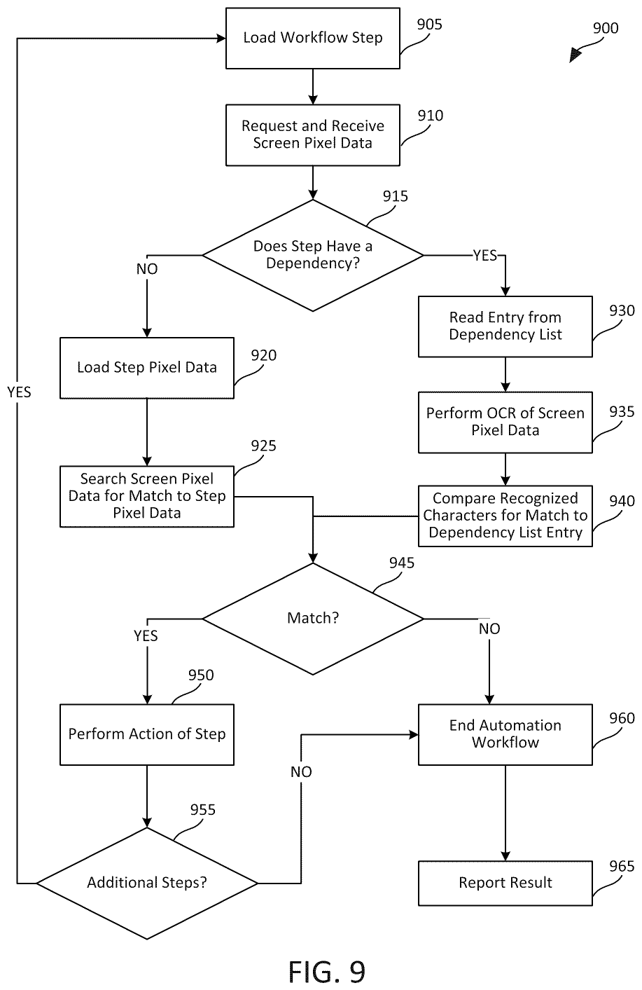

If a user input 106 indicates the specified action is a dependency, then, at a step 820, the token recording engine 108 may add a dependency to the token workflow. As explained in detail below in reference to FIG. 9, the token playback engine 212 may, for example, read an entry from the dependency list for a dependency workflow step and perform OCR to determine the location of the entry in the screen pixel data 112. Upon selection of the dependency option (e.g., “add dependency”), the user 102 may be prompted to select a specified action corresponding to the dependency. For example, if the dependency involves selecting an entry from a drop down list, a left mouse click may be selected as the specified action associated with the dependency workflow step for selection of the dependency entry.

If, at the decision 815, the token recording engine 108 determines that the user input 106 is not a dependency, such as if the user input 106 is a left mouse click or the “record click” option was selected from the recording menu 146 as shown in FIG. 1E, then, at a step 825 of the routine 800, the token recording engine 108 may capture recorded pixel data from the screen pixel data 112. The user input(s) 106 may thus indicate the specified action (e.g., left mouse click) and the coordinate data corresponding to the specified location at which the indicated action is to be taken.

As described above in reference to FIG. 1A, the token recording engine 108 may request the screen pixel data 112 from the operating system 114. For example, in some implementations, the token recording engine 108 may make a request for screen pixel data to the operating system 114 via one or more APIs of the operating system 114. In response, as illustrated, the operating system 114 may capture screen pixel data 112 of the screen buffer 120 and return that captured screen pixel data 112 to the token recording engine 108. The token recording engine 108 may identify recorded pixel data (e.g., color value and coordinate data) for a plurality of pixels within a proximity the specified location at which the indicated action is to be taken. In some implementations, the token recording engine 108 may have predefined parameters for a number of pixels to capture and a proximity of the specified location to capture (i.e., record) pixels. For example, the token recording engine 108 may be configured to capture twenty pixels that are within a ten pixel radius of the specified location at which the indicated action is to be taken.

At a step 830 of the routine 800, the token recording engine 108 may add the recorded pixel data and the specified action of the user input 106 to the token workflow. Following the step 820 or the step 830, the routine 800 may return to the step 805 to receive the next user input(s) 106. In some implementations, the routine 800 may repeat the steps 805-830 to generate the token workflow until a user input 106 is received indicating to stop the recording.

As described above, at the decision 810, the token recording engine may determine if the received user input 106 indicates to stop the token recording process. If the user input 106 indicates to stop the token recording process, as shown in FIG. 1I, then the routine 800 may proceed to a step 835, at which the token recording engine 108 may present to the user 102 a prompt to provide a name for the token 118. At a step 840 of the routine 800, the token recording engine 108 may store, such as in a database, local memory of the client device 302, etc., the token, including the token workflow and the recorded pixel data for the respective workflow steps. After storing the token workflow, the routine 800 may terminate.

FIG. 9 illustrates an example routine 900 that may be performed by the token playback engine 212 for executing a token workflow, in accordance with some embodiments. As described above, the token playback engine 212 may be configured to automate interactions with a GUI rendered by a browser 132, and may embodied within, or be an add-in or plug-in of, such a browser. Alternatively, the token playback engine 212 may interact with a browser 132 or other application in some other way, such through an application programming interface (API) of the application/browser to enable the functionality described herein.

As shown in FIG. 2B, the screen 240 of the resource access application 622 may include the “tokens” UI element 222 that, when selected, may present icons or other descriptors corresponding to previously generated tokens 118. As described in reference to FIG. 2B, the user 102 may select a displayed token 118 (e.g., the first token 118a or the second token 118b) for execution, such as by double clicking on it.

As shown in FIG. 2A, selection of a token 118 in such a manner may trigger the communication of a token execution instruction 202 to the token playback engine 212. The token execution instruction may trigger the token playback engine 212 to begin executing the token workflow defined by the token 118. In some instances, as described in reference to FIG. 2C, the user 102 may be prompted to select a dependency list from the dependency list selection element 226 if the selected token 118 includes at least one dependency.

Upon receiving selection of the displayed token 118 for execution, instructions may be provided to the operating system 114 to open an application (e.g., the web browser 132). Further instructions may then be provided to the token playback engine 212 to begin executing the selected token 118. In some implementations, the token playback engine 212 may load the stored data corresponding to the token to begin executing the token workflow (e.g., the playback process) of the token 118. In some implementations, as noted above, the token 118 may include a recorded URL that was recorded from the web page address bar 128 of the web browser 132 by the token recording engine 108. In some implementations, such a recorded URL may identify a “starting” web page to which a browser 132 is to navigate when the token 118 is executed by the token playback engine 212. The token playback engine 212 may provide the recorded URL to the application (e.g., the web browser 132). The application may load the “starting” web page associated with the recorded URL for the playback process to proceed.

As shown in FIG. 9, in some implementations, the routine 900 may begin at a step 905, at which the token playback engine 212 may load a workflow step by reading instructions for a workflow step from the token 118 to begin execution of the token workflow corresponding to the selected token 118.

Upon reading the instructions for the workflow step, at a step 910 of the routine 900, the token playback engine 212 may request and receive the captured screen pixel data 208, as shown in FIG. 2A. At a decision 915 of the routine 900, the token playback engine 212 may determine if the current workflow step includes a dependency.

If the current workflow step does not include a dependency, then following the decision 915, the token playback engine 212 may, at a step 920 of the routine 900, load the recorded pixel data of the current workflow step from the token workflow. At a step 925 of the routine 900, the token playback engine 212 may search the captured screen pixel data 208 for pixels that correspond to the recorded pixel data, based on the color values and coordinate data of the respective pixels of the recorded pixel data. The token playback engine 212 may search the captured screen pixel data 208 for pixels that have the substantially the same color values and substantially the same relative positions as the recorded pixel data. As previously described in reference to FIG. 2A, the relative positions, or coordinate data, of the pixels may use the Cartesian coordinate system with the coordinate data for the respective pixels of the recorded pixel data determined based on the pixel distance from the specified action location.

If the current workflow step does include a dependency, then following the decision 915, the token playback engine 212 may, at a step 930 of the routine 900, read into memory the next entry from the dependency list as a current dependency entry. As one example, the dependency list shown in FIG. 2D includes two entries: “File_B.java” and “File_C.java.” Thus, for the first iteration of the token workflow, the token playback engine 212 may read the first entry “File_B.java” from the dependency list and, for the second iteration of the token workflow, the token playback engine 212 may read the second entry “File_C.java” from the dependency list. Dependency lists may be stored, for example, in a database or other storage medium and may be accessed by the token playback engine 212 upon execution of a token workflow.

At a step 935 of the routine 900, the token playback engine 212 may perform OCR of the captured screen pixel data 208 to identify alphanumeric characters in the captured screen pixel data 208, with the result being textual character data. At a step 940 of the routine 900, the token playback engine 212 may then compare the current dependency entry with the textual character data to determine if the current dependency entry is part of the textual character data. For example, the token playback engine 212 may compare the textual character data with the character sequence “File_B.java” to determine if the current dependency entry is part of the textual character data. If the current dependency entry is located in the textual character data, then token playback engine 212 may store the location (e.g., coordinate data) of the current dependency entry in the textual character data.

At a decision 945 of the routine 900, the token playback engine 212 may indicate if a match for the recorded pixel data or current dependency entry has been identified in the captured screen pixel data 208. If the token playback engine 212 has identified a match for either the recorded pixel data or the current dependency entry, then, at a step 950 of the routine 900, the token playback engine 212 may provide instructions to the operating system 114 to perform the action (e.g., invoke a left mouse click operation) of the current workflow step. As noted previously, in some implementations, such an action (e.g., a left mouse click) may be invoked at a position relative to the matching pixels that is the same as the position of the step recording action (e.g., a mouse click the triggered the recording of the pixel data for the step) relative to recorded pixel data.

Upon instructing the operating system 114 to perform the specified action of the workflow step, at decision 955 of the routine 900, the token playback engine 212 may determine if there are additional workflow steps of the token workflow of the token 118. If there are remaining workflow steps of the token workflow, then the routine 900 may return to the step 905, at which the token playback engine 212 may read the instructions for the next workflow step.

If, at decision 955, the token playback engine 212 determines there are no remaining workflow steps for the token 118, then, at a step 960 of the routine 900, the token playback engine 212 may end the execution of the token workflow of the token 118. Similarly, if at decision 945 the token playback engine 212 does not indicate a match for the recorded pixel data or that the current dependency entry has been identified in the captured screen pixel data 208, then, at the step 960, the token playback engine 212 may end the execution of the token workflow of the token 118.

Upon ending the token workflow at the step 960, the token playback engine 212 may, at a step 965 of the routine 900, generate a report for the token 118 execution. In some implementations, the report may include a success indication for the one or more iterations of the token workflow. For example, if the routine 900 reaches the decision 955 and there are no remaining workflow steps, then the iteration may be indicated as a success. Alternatively, if at the decision 945 a match for either the recorded pixel data or current dependency entry, depending on the type of workflow step, is not identified, then the iteration may be indicated as a failure.

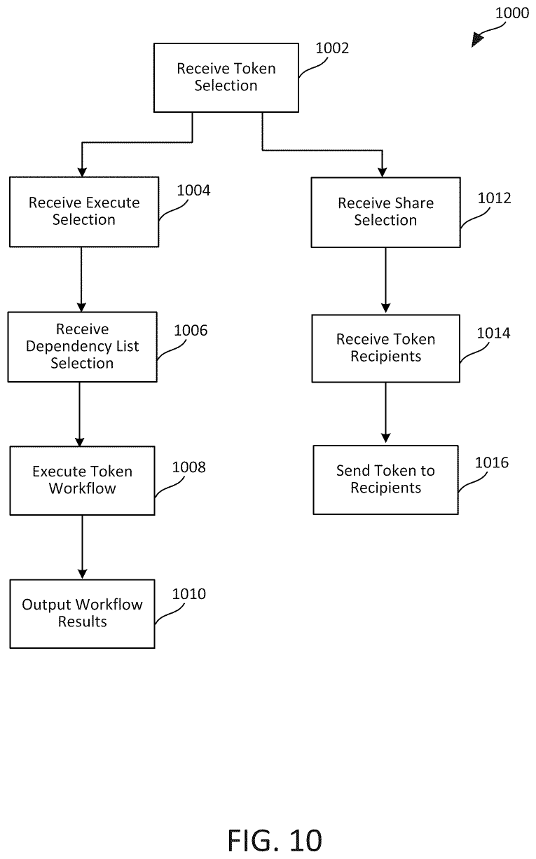

FIG. 10 illustrates an example routine 1000 including various processes for a token 118, in accordance with some embodiments. At a step 1002 of the routine 1000, a computing device may receive one or more user inputs 106 for selection of a token workflow. As shown in FIG. 2B, the resource access application 622 may, for example, include a “tokens” UI element 222 that, when selected, may reveal a set of one or more icons corresponding to tokens 118 that are available to the user 102. Upon selection of such an icon, the display 122 may display one or more token options, such as an “execute” option and/or a “share” option.

At a step 1004 of the routine 1000, the computing device may receive an “execute” selection. In some implementations, if the selected token 118 includes a dependency, then a dependency list selection element 226, e.g., as shown in FIG. 2C, may be displayed. At a step 1006 of the routine 1000, the computing device may receive a dependency list selection. At a step 1008 of the routine 1000, the computing device may execute the token workflow of the token 118, as described in reference to FIG. 9.

At a step 1010 of the routine 1000, upon completion of the token workflow execution, the computing device may output, such as for presenting on the display 122, the results of the token workflow execution. The results of the token workflow execution may indicate whether the token workflow executed successfully or failed, in whole or in part. If the token workflow included a dependency, then the results may indicate the success or failure for the respective dependencies of the dependency list.

In some implementations, the token 118 may be shared with other users. After the step 1002 of receiving the token 118 selection, the computing device may, at a step 1012 of the routine 1000, receive a selection to share the token 118. At a step 1014 of the routine 1000, the computing device may receive identification for one or more recipients of the token 118. For example, the user 102 may provide email addresses for the one or more recipients. At a step 1016 of the routine 1000, the computing device may send the token 118 to the one or more recipients, such as by sending an email with the token 118 as an attachment.

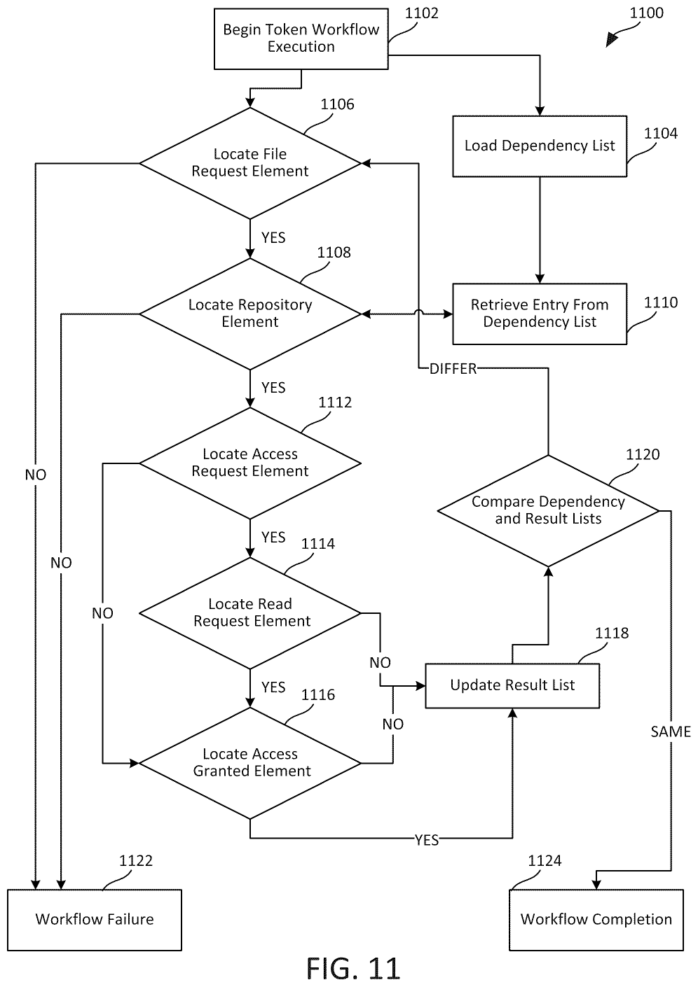

FIG. 11 shows an example routine 1100 for the playback execution of a file access request token, in accordance with some embodiments. The file access request token may, for example, be configured with workflow steps to request read level access to one or more files. The file access request token may iterate based on the number of file name entries in the selected dependency list. At a step 1102 of the example routine 1100, the execution of the token workflow for the file access request token may begin. As shown in FIG. 10, after receiving the selection of the file access request token at the step 1002, receiving the selection to execute the file access request token at the step 1004, and receiving the dependency list selection at the step 1006, the token playback engine 212 may execute the workflow for the file access request token at the step 1008, thus resulting in the start of the workflow execution at the step 1102.

As described in reference to FIG. 9, upon execution of the token workflow for the file access request token, the operating system 114 may be instructed to open the browser 132. The token playback engine 212 may provide the browser 132 with the URL stored by the file access request token. In some implementations, the resource access application 622 may provide an indication to an add-in or plug-in (e.g., the token playback engine 212) of the browser 132 to execute the token workflow.

Upon beginning execution of the token workflow for the file access request token, at a step 1104 of the example routine 1100, the token playback engine 212 may load the selected dependency list, as the file access request token includes a dependency. As described in reference to the step 1006 of the routine 1000, the token playback engine 212 may receive a dependency list selection before execution of the token workflow begins.

After loading the dependency list at a step 1104, the execution of the workflow steps of the file access request token may commence. At a decision step 1106 of the example routine 1100, the token playback engine 212 may attempt to locate a file request UI element. As described in reference to FIG. 9, the workflow step may include recorded pixel data corresponding to the file request UI element. The token playback engine 212 may then attempt to match the recorded pixel data, based on color values and relative coordinate data, to pixels of the captured screen pixel data 208. If the token playback engine 212 successfully matches the recorded pixel data, as described in the step 925 of the routine 900, then the token playback engine 212 may send instructions to the operating system 114 to perform the specified action corresponding to the decision step 1106. For example, the instructions may be to perform a single left mouse click at coordinates of the screen buffer 120 based on the relative coordinate data of the recorded pixel data. In some implementations, the specified action of the workflow step may have additional instructions for the token playback engine 212, such as a time delay (e.g., wait two seconds) before moving on to the next workflow step.

If the token playback engine 212 successfully locates the file request UI element, per the decision step 1106 of the example routine 1100, then, at a decision step 1108 of the example routine 1100, the token playback engine 212 may attempt to locate a repository element. In some instances, the token playback engine 212 may determine that a workflow step has a dependency. In the instance of the decision step 1108, the workflow step has a dependency, and thus, per a step 1110 of the example routine 1100, the token playback engine 212 may retrieve the next dependency list entry from the dependency list. As described in reference to the steps 930, 935, and 940 of the routine 900, the token playback engine 212 may perform OCR of the captured screen pixel data 208 and then attempt to locate the repository element (e.g., the dependency list entry) in the determined textual character data. If the token playback engine 212 successfully matches the repository element, then the token playback engine 212 may send instructions to the operating system 114 to perform the action corresponding to the decision step 1108. For example, the instructions may be to perform a single left mouse click at coordinates of the screen buffer 120 based on coordinate data of the captured screen pixel data 208 corresponding to the center of the located repository element.

In the example routine 1100, if either the decision step 1106 or the decision step 1108 is unsuccessful, then at a step 1122 of the routine 1100, the token playback engine 212 may determine a workflow failure of the file access request token. In this instance, the token playback engine 212 has been unsuccessful at locating the file request UI element or the repository UI element and thus the file access request token execution must end. For example, the resource access application 622 may be experiencing network connectivity problems and may thus be unable to load the web pages for the file repository.

If the token playback engine 212 successfully locates the repository UI element, per the decision step 1108 of the example routine 1100, then, at a decision step 1112 of the example routine 1100, the token playback engine 212 may attempt to locate an access request UI element. Similar to the decision step 1106, the token playback engine 212 may locate the access request UI element using the recorded pixel data of the workflow step and upon successfully locating the access request UI element, send instructions to the operating system 114 to perform the action corresponding to the decision step 1112.

In the instance of the illustrated example of FIG. 11, the access request element may expand to display options and so the user 102 may be presented with different options for the type of file access being requested. For example, a first access option may be “read” and a second access option may be “write.” At a decision step 1114 of the example routine 1100, the token playback engine 212 may attempt to locate the “read” request element of the access request element. Thus, in the instance of the file access request token illustrated in FIG. 11, the access option requested is “read,” instead of another option, such as “write.” Upon locating the read request element, the token playback engine 212 may send instructions to the operating system 114 to select the read option by performing a mouse click at the screen coordinate data provided by the token playback engine 212.

Alternatively, if at the decision step 1112 of routine 1100, the access request element is not located, the token playback engine 212 may proceed to a decision step 1116 of the example routine 1100. For example, the user 102 may have been previously granted access to the file and thus the access request element may not be displayed. If the access request UI element is not located at the decision step 1112, then at the decision step 1116 of the example routine 1100, the token playback engine 212 may attempt to locate an access granted element that may be used to confirm that access to the requested file had been previously granted.

If the token playback engine 212 successfully locates the read request element, then at the decision step 1116 of the example routine 1100, the token playback engine 212 may attempt to locate an access granted UI element that may be used to confirm that access to the requested file has been granted. If the access granted element is successfully located per the decision step 1116, then at a step 1118 of the routine 1100, a result list may be updated with the current dependency list entry and an indication that this iteration of the workflow execution was successful. As the decision step 1116 is a confirmation step of the workflow, the workflow step corresponding to the decision step 1116 may not include an action (e.g., mouse click).

Alternatively, if at the decision step 1114 the read request UI element is not located by the token playback engine 212 or if at the decision step 1116 the access granted UI element is not located by the token playback engine 212, then the decision step 1114 or the decision step 1116 were unsuccessful and the result list may be updated at the step 1118 accordingly. For example, the result list may be updated with the current dependency list entry and an indication that this iteration of the workflow execution was unsuccessful.

After updating the result list at the step 1118, at a decision step 1120 of the example routine 1100, the token playback engine 212 may compare the present result list to the dependency list. If the token playback engine 212 determines that the two lists differ (i.e., the result list does not include all of the entries from the dependency list), then this may indicate there are additional iterations of the workflow for the file access request token to perform. The routine 1100 may then return to the decision step 1106 and continue with the next iteration of the workflow. Alternatively, if the token playback engine 212 determines at the decision step 1120 that the result list and dependency list are the same (i.e., both lists contain the same entries), then the iterations of the workflow are complete. At a step 1124 of the routine 1100, the token playback engine 212 may determine the workflow has completed and generate a report based on the result list. For example, the report may include the entries from the dependency list and an indication if the workflow execution for the corresponding entry was successful or unsuccessful.

G. Example Implementations of Methods, Systems, and Computer-Readable Media in Accordance with the Present Disclosure

The following paragraphs (M1) through (M15) describe examples of methods that may be implemented in accordance with the present disclosure.

(M1) A method may be performed that involves determining, in response to at least one first input to a user interface of a computing system, that at least one first action is to be taken with respect to a first user interface (UI) element being displayed by the user interface; determining, by the computing system, first pixel data corresponding to the first UI element; and generating, by the computing system, a script configured to determine that first pixels corresponding to the first pixel data are being displayed on a screen of a computing device, and to, based at least in part on the first pixels corresponding to the first pixel data, cause the computing device to take the at least one first action at first coordinates corresponding to a first location on the screen at which of the first pixels are being displayed.

(M2) A method may be performed as described in paragraph (M1), wherein the first pixel data may identify at least one color value and at least one screen location corresponding to the at least one color value.

(M3) A method may be performed as described in paragraph (M1) or paragraph (M2), and may further involve determining, by the computing system, a first coordinate corresponding to the at least one first input; wherein determining the first pixel data corresponding to the first UI element may include identifying at least one pixel of the user interface within a vicinity of the first coordinate.

(M4) A method may be performed as described in any of paragraphs (M1) through (M3), and may further involve determining, in response to at least one second input to the user interface of the computing system, that at least one second action is to be taken with respect to a second UI element being displayed by the user interface, wherein the at least one second input indicates a textual dependency; and further generating, by the computing system, the script to further be configured to determine first textual data associated with the script, to determine second textual data by performing optical character recognition of second pixel data being displayed on the screen of the computing device, to determine that the first textual data corresponds to the second textual data, and to, based at least in part on determining the first textual data corresponds to the second textual data, cause the computing device to take the at least one second action at second coordinates corresponding to a second location on the screen at which at least one element corresponding to the first textual data is being displayed.

(M5) A method may be performed as described in any of paragraphs (M1) through paragraph (M4), wherein the user interface may be rendered by a browser.

(M6) A method may be performed as described in paragraph (M5), wherein the script may include a uniform resource locator (URL) corresponding to a web page to be initially rendered by the browser.

(M7) A method may be performed as described in paragraph (M5) or paragraph (M6), wherein the method may be performed by a component of the browser.

(M8) A method may be performed that involves determining, by a computing device, that a script identifies first pixel data and at least one first action associated with the first pixel data; determining that first pixels being displayed on a screen of the computing device correspond to the first pixel data identified in the script; and based at least in part on the first pixels corresponding to the first pixel data and the at least one first action being associated with the first pixel data in the script, causing the computing device to take the at least one first action at first coordinates corresponding to a first location on the screen at which of the first pixels are being displayed.

(M9) A method may be performed as described in paragraph (M8), wherein the first pixel data may identify at least one color value and at least one screen location corresponding to the at least one color value.

(M10) A method may be performed as described in paragraph (M9), and may further involve determining the first coordinates based on the at least one screen location identified by the first pixel data.

(M11) A method may be performed as described in any of paragraphs (M8) through (M10), and may further involve determining, by the computing device, first textual data associated with the script and at least one second action associated with the first textual data; determining that second textual data being displayed on the screen of the computing device corresponds to the first textual data associated with the script; and based at least in part on the second textual data corresponding to the first textual data and the at least one second action being associated with the first textual data, causing the computing device to take the at least one second action at second coordinates corresponding to a second location on the screen at which at least one element corresponding to the first textual data is being displayed

(M12) A method may be performed as described in any of paragraphs (M8) through (M11), and may further involve determining a first number of the first pixels corresponding to the first pixel data exceeds a threshold value.

(M13) A method may be performed as described in any of paragraphs (M8) through (M12), wherein the first pixels may be rendered by a browser.

(M14) A method may be performed as described in paragraph (M13), and may further involve rendering, by the browser, a web page corresponding to a uniform resource locator (URL) included in the script.

(M15) A method may be performed as described in any of paragraph (M13) or paragraph (M14), wherein the method may be performed by a component of the browser.

The following paragraphs (S1) through (S15) describe examples of systems and devices that may be implemented in accordance with the present disclosure.

(S1) A computing system may include at least one processor, and at least one computer-readable medium encoded with instructions which, when executed by the at least one processor, cause the computing system to determine, in response to at least one first input to a user interface of a computing system, that at least one first action is to be taken with respect to a first user interface (UI) element being displayed by the user interface, to determine first pixel data corresponding to the first UI element, and to generate by the computing system, a script configured to determine that first pixels corresponding to the first pixel data are being displayed on a screen of a computing device, and to, based at least in part on the first pixels corresponding to the first pixel data, cause the computing device to take the at least one first action at first coordinates corresponding to a first location on the screen at which of the first pixels are being displayed.

(S2) A computing system may be configured as described in paragraph (S1), wherein the first pixel data may identify at least one color value and at least one screen location corresponding to the at least one color value.

(S3) A computing system may be configured as described in paragraph (S1) or paragraph (S2), and the at least one computer-readable medium may be further encoded with additional instructions which, when executed by the at least one processor, further cause the computing system to determine a first coordinate corresponding to the at least one first input, and to determine the first pixel data corresponding to the first UI element at least in part by identifying at least one pixel of the user interface within a vicinity of the first coordinate.

(S4) A computing system may be configured as described in any of paragraphs (S1) through paragraph (S3), and the at least one computer-readable medium may be further encoded with additional instructions which, when executed by the at least one processor, further cause the computing system to determine, in response to at least one second input to the user interface of the computing system, that at least one second action is to be taken with respect to a second UI element being displayed by the user interface, wherein the at least one second input may indicate a textual dependency, and to further generate the script to further be configured to determine first textual data associated with the script, to determine second textual data by performing optical character recognition of second pixel data being displayed on the screen of the computing device, to determine that the first textual data corresponds to the second textual data, and to, based at least in part on determining the first textual data corresponds to the second textual data, cause the computing device to take the at least one second action at second coordinates corresponding to a second location on the screen at which at least one element corresponding to the first textual data is being displayed.

(S5) A computing system may be configured as described in any of paragraphs (S1) through (S4), and may further include a browser configured to render the first pixels.

(S6) A computing system may be configured as described in paragraph (S5), wherein the script may include a uniform resource locator (URL) corresponding to a web page to be initially rendered by the browser.

(S7) A computing system may be configured as described in paragraph (S5) or paragraph (S6), wherein the browser may include at least one component configured to execute the script.

(S8) A computing system may include at least one processor, and at least one computer-readable medium encoded with instructions which, when executed by the at least one processor, cause the computing system to determine, by a computing device, that a script identifies first pixel data and at least one first action associated with the first pixel data, to determine that first pixels being displayed on a screen of the computing device correspond to the first pixel data identified in the script, and to, based at least in part on the first pixels corresponding to the first pixel data and the at least one first action being associated with the first pixel data in the script, cause the computing device to take the at least one first action at first coordinates corresponding to a first location on the screen at which of the first pixels are being displayed.

(S9) A computing system may be configured as described in paragraph (S8), wherein the first pixel data may identify at least one color value and at least one screen location corresponding to the at least one color value.

(S10) A computing system may be configured as described in paragraph (S9), and the at least one computer-readable medium may be further encoded with additional instructions which, when executed by the at least one processor, further cause the computing system to determine the first coordinates based on the at least one screen location identified by the first pixel data.

(S11) A computing system may be configured as described in any of paragraphs (S8) through (S10), and the at least one computer-readable medium may be further encoded with additional instructions which, when executed by the at least one processor, further cause the computing system to determine by the computing device, first textual data associated with the script and at least one second action associated with the first textual data, to determine that second textual data being displayed on the screen of the computing device corresponds to the first textual data associated with the script, and to, based at least in part on the second textual data corresponding to the first textual data and the at least one second action being associated with the first textual data, cause the computing device to take the at least one second action at second coordinates corresponding to a second location on the screen at which at least one element corresponding to the first textual data is being displayed

(S12) A computing system may be configured as described in any of paragraphs (S8) through (S11), and the at least one computer-readable medium may be further encoded with additional instructions which, when executed by the at least one processor, further cause the computing system to determine a first number of the first pixels corresponding to the first pixel data exceeds a threshold value.

(S13) A computing system may be configured as described in any of paragraphs (S8) through (S12), and may further include a browser configured to render the first pixels.

(S14) A computing system may be configured as described in paragraph (S13), and the at least one computer-readable medium may be further encoded with additional instructions which, when executed by the at least one processor, further cause the computing system to render, by the browser, a web page corresponding to a uniform resource locator (URL) included in the script.

(S15) A computing system may be configured as described in paragraph (S13) or paragraph (S14), wherein the browser may include at least one component configured to execute the script.

The following paragraphs (CRM1) through (CRM15) describe examples of computer-readable media that may be implemented in accordance with the present disclosure.

(CRM1) At least one non-transitory computer-readable medium may be encoded with instructions which, when executed by at least one processor of a computing system, cause the computing system to determine, in response to at least one first input to a user interface of At least one non-transitory computer-readable medium, that at least one first action is to be taken with respect to a first user interface (UI) element being displayed by the user interface, to determine first pixel data corresponding to the first UI element, and to generate by the computing system, a script configured to determine that first pixels corresponding to the first pixel data are being displayed on a screen of a computing device, and to, based at least in part on the first pixels corresponding to the first pixel data, cause the computing device to take the at least one first action at first coordinates corresponding to a first location on the screen at which of the first pixels are being displayed.

(CRM2) At least one non-transitory computer-readable medium may be configured as described in paragraph (CRM1), wherein the first pixel data may identify at least one color value and at least one screen location corresponding to the at least one color value.

(CRM3) At least one non-transitory computer-readable medium may be configured as described in paragraph (CRM1) or paragraph (CRM2), and may be further encoded with additional instructions which, when executed by the at least one processor, further cause the computing system to determine a first coordinate corresponding to the at least one first input, and to determine the first pixel data corresponding to the first UI element at least in part by identifying at least one pixel of the user interface within a vicinity of the first coordinate.

(CRM4) At least one non-transitory computer-readable medium may be configured as described in any of paragraphs (CRM1) through paragraph (CRM3), and may be further encoded with additional instructions which, when executed by the at least one processor, further cause the computing system to determine, in response to at least one second input to the user interface of the computing system, that at least one second action is to be taken with respect to a second UI element being displayed by the user interface, wherein the at least one second input may indicate a textual dependency, and to further generate the script to further be configured to determine first textual data associated with the script, to determine second textual data by performing optical character recognition of second pixel data being displayed on the screen of the computing device, to determine that the first textual data corresponds to the second textual data, and to, based at least in part on determining the first textual data corresponds to the second textual data, cause the computing device to take the at least one second action at second coordinates corresponding to a second location on the screen at which at least one element corresponding to the first textual data is being displayed.

(CRM5) At least one non-transitory computer-readable medium may be configured as described in any of paragraphs (CRM1) through (CRM4), and may be further encoded with additional instructions which, when executed by the at least one processor, further cause the computing system to render the user interface using a browser.

(CRM6) At least one non-transitory computer-readable medium may be configured as described in paragraph (CRM5), wherein the script may include a uniform resource locator (URL) corresponding to a web page to be initially rendered by the browser.

(CRM7) At least one non-transitory computer-readable medium may be configured as described in paragraph (CRM5) or paragraph (CRM6), and may be further encoded with additional instructions which, when executed by the at least one processor, further cause the computing system to execute the script using at least one component of the browser.

(CRM8) At least one non-transitory computer-readable medium may be encoded with instructions which, when executed by at least one processor of a computing system, cause the computing system to determine, by a computing device, that a script identifies first pixel data and at least one first action associated with the first pixel data, to determine that first pixels being displayed on a screen of the computing device correspond to the first pixel data identified in the script, and to, based at least in part on the first pixels corresponding to the first pixel data and the at least one first action being associated with the first pixel data in the script, cause the computing device to take the at least one first action at first coordinates corresponding to a first location on the screen at which of the first pixels are being displayed.

(CRM9) At least one non-transitory computer-readable medium may be configured as described in paragraph (CRM8), wherein the first pixel data may identify at least one color value and at least one screen location corresponding to the at least one color value.

(CRM10) At least one non-transitory computer-readable medium may be configured as described in paragraph (CRM9), and may be further encoded with additional instructions which, when executed by the at least one processor, further cause the computing system to determine the first coordinates based on the at least one screen location identified by the first pixel data.

(CRM11) At least one non-transitory computer-readable medium may be configured as described in any of paragraphs (CRM8) through (CRM10), and may be further encoded with additional instructions which, when executed by the at least one processor, further cause the computing system to determine by the computing device, first textual data associated with the script and at least one second action associated with the first textual data, to determine that second textual data being displayed on the screen of the computing device corresponds to the first textual data associated with the script, and to, based at least in part on the second textual data corresponding to the first textual data and the at least one second action being associated with the first textual data, cause the computing device to take the at least one second action at second coordinates corresponding to a second location on the screen at which at least one element corresponding to the first textual data is being displayed

(CRM12) At least one non-transitory computer-readable medium may be configured as described in any of paragraphs (CRM8) through (CRM11), and may be further encoded with additional instructions which, when executed by the at least one processor, further cause the computing system to determine a first number of the first pixels corresponding to the first pixel data exceeds a threshold value.

(CRM13) At least one non-transitory computer-readable medium may be configured as described in any of paragraphs (CRM8) through (CRM12), and may be further encoded with additional instructions which, when executed by the at least one processor, further cause the computing system to render the first pixels using a browser.

(CRM14) At least one non-transitory computer-readable medium may be configured as described in paragraph (CRM13), and may be further encoded with additional instructions which, when executed by the at least one processor, further cause the computing system to render, by the browser, a web page corresponding to a uniform resource locator (URL) included in the script.

(CRM15) At least one non-transitory computer-readable medium may be configured as described in paragraph (CRM13) or paragraph (CRM14), and may be further encoded with additional instructions which, when executed by the at least one processor, further cause the computing system to execute the script using at least one component of the browser.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method, comprising:
determining, in response to at least one first input to a user interface of a computing system, that at least one first action is to be taken with respect to a first user interface (UI) element being displayed by the user interface;
determining, by the computing system, first pixel data corresponding to the first UI element; and
generating, by the computing system, a script configured to:
determine that first pixels corresponding to the first pixel data are being displayed on a screen of a computing device, and
based at least in part on the first pixels corresponding to the first pixel data, cause the computing device to take the at least one first action at first coordinates corresponding to a first location on the screen at which of the first pixels are being displayed.

2. The method of claim 1, wherein the first pixel data identifies at least one color value and at least one screen location corresponding to the at least one color value.

3. The method of claim 1, further comprising:
determining, by the computing system, a first coordinate corresponding to the at least one first input;
wherein determining the first pixel data corresponding to the first UI element includes identifying at least one pixel of the user interface within a vicinity of the first coordinate.

4. The method of claim 1, further comprising:
determining, in response to at least one second input to the user interface of the computing system, that at least one second action is to be taken with respect to a second UI element being displayed by the user interface, wherein the at least one second input indicates a textual dependency; and
further generating, by the computing system, the script to further be configured to:
determine first textual data associated with the script;
determine second textual data by performing optical character recognition of second pixel data being displayed on the screen of the computing device;
determine that the first textual data corresponds to the second textual data; and
based at least in part on determining the first textual data corresponds to the second textual data, cause the computing device to take the at least one second action at second coordinates corresponding to a second location on the screen at which at least one element corresponding to the first textual data is being displayed.

5. The method of claim 1, wherein the user interface is rendered by a browser.

6. The method of claim 5, wherein the script includes a uniform resource locator (URL) corresponding to a web page to be initially rendered by the browser.

7. The method of claim 5, wherein the method is performed by a component of the browser.

8. A method, comprising:
determining, by a computing device, that a script identifies first pixel data and at least one first action associated with the first pixel data;
determining that first pixels being displayed on a screen of the computing device correspond to the first pixel data identified in the script; and
based at least in part on the first pixels corresponding to the first pixel data and the at least one first action being associated with the first pixel data in the script, causing the computing device to take the at least one first action at first coordinates corresponding to a first location on the screen at which of the first pixels are being displayed.

9. The method of claim 8, wherein the first pixel data identifies at least one color value and at least one screen location corresponding to the at least one color value.

10. The method of claim 9, further comprising:
determining the first coordinates based on the at least one screen location identified by the first pixel data.

11. The method of claim 8, further comprising:
determining, by the computing device, first textual data associated with the script and at least one second action associated with the first textual data;
determining that second textual data being displayed on the screen of the computing device corresponds to the first textual data associated with the script; and
based at least in part on the second textual data corresponding to the first textual data and the at least one second action being associated with the first textual data, causing the computing device to take the at least one second action at second coordinates corresponding to a second location on the screen at which at least one element corresponding to the first textual data is being displayed.

12. The method of claim 8, further comprising:
determining a first number of the first pixels corresponding to the first pixel data exceeds a threshold value.

13. The method of claim 8, wherein the first pixels are being rendered by a browser.

14. The method of claim 13, further comprising:
rendering, by the browser, a web page corresponding to a uniform resource locator (URL) included in the script.

15. The method of claim 13, wherein the method is performed by a component of the browser.

16. A computing system, comprising:
at least one processor; and
at least one computer-readable medium encoded with instructions which, when executed by the at least one processor, cause the computing system to:
determine that a script identifies first pixel data and at least one first action associated with the first pixel data;
determine that first pixels being displayed on a screen of a computing device correspond to the first pixel data identified in the script; and
based at least in part on the first pixels corresponding to the first pixel data and the at least one first action being associated with the first pixel data in the script, cause the computing device to take the at least one first action at first coordinates corresponding to a first location on the screen at which of the first pixels are being displayed.

17. The computing system of claim 16, wherein the first pixel data identifies at least one color value and at least one screen location corresponding to the at least one color value.

18. The computing system of claim 17, wherein the at least one computer-readable medium is further encoded with additional instructions which, when executed by the at least one processor, further cause the computing system to:
determine the first coordinates based on the at least one screen location identified by the first pixel data.

19. The computing system of claim 16, further comprising a browser configured to render the first pixels.

20. The computing system of claim 19, wherein the browser includes at least one component configured to execute the script.
